(19) United States
(12) Patent Application Publication
(10) Pub. No.: US 2012/0064464 A1
(43) Pub. Date: Mar. 15, 2012

(54) RADIOGRAPHIC SILVER HALIDE FILMS HAVING INCORPORATED DEVELOPER

(76) Inventors: Alan S. Fitterman, Rochester, NY (US); Robert E. Dickerson, Hamlin, NY (US); Mark P. Pavlik, Rochester, NY (US); Lynn M. Tremblay, Rochester, NY (US)

(21) Appl. No.: 13/256,458

(22) PCT Filed: Mar. 11, 2010
(86) PCT No.: PCT/US2010/000728

§ 371 Date: Nov. 4, 2011

Related U.S. Application Data
(60) Provisional application No. 61/163,965, filed on Mar. 27, 2009.
(60) Provisional application No. 61/251,753, filed on Oct. 15, 2009.

(51) Int. Cl. G03C 5/38; G03C 5/26

(52) U.S. Cl. 430/405; 430/502; 430/542

(57) ABSTRACT

Radiographic silver halide materials coated onto a support contain a portion of the developer chemistry incorporated within the radiographic film. The remainder of the developer chemistry is contained in a developer solution. Use of a reflective support permits the developed materials to be viewed without a light box.

### CROSS REFERENCE TO RELATED APPLICATIONS

This application claims priority to U.S. Provisional Patent Application No. 61/163,965, filed Mar. 27, 2009 and U.S. Provisional Patent Application No. 61/251,753, filed Oct. 15, 2009, both entitled “RADIOGRAPHIC SILVER HALIDE FILMS HAVING INCORPORATED DEVELOPER,” both applications incorporated herein by reference in their entirety.

### FIELD OF THE INVENTION

This invention relates in general to photography and in particular to radiographic silver halide materials coated onto reflective and transmissive supports. At least a portion of the developer chemistry is incorporated within the radiographic film. The remainder of the developer chemistry is contained in a developer solution. The invention also relates to methods of imaging and developing these materials and to kits comprising various developing compositions.

### BACKGROUND OF THE INVENTION

In conventional medical diagnostic imaging, the object is to obtain an image of a patient's internal anatomy with as little X-radiation exposure as possible. The fastest imaging speeds are realized by mounting a duplitized radiographic silver halide material between a pair of fluorescent intensifying screens for imagewise exposure. About 5% or less of the exposing X-radiation passing through the patient is absorbed directly by the latent image forming silver halide emulsion layers within the duplitized material. Most of the X-radiation that participates in image formation is absorbed by phosphor particles within the fluorescent screens. This stimulates light emission that is more readily absorbed by the silver halide emulsion layers.

Examples of radiographic silver halide materials that are useful for medical diagnostic purposes are described in U.S. Pat. Nos. 4,425,425 (Abbott et al.), 4,425,426 (Abbott et al.), 4,414,310 (Dickerson), 4,803,150 (Dickerson et al.), 4,900,652 (Dickerson et al.), 5,252,442 (Tsaur et al.), and 5,576,156 (Dickerson), and Research Disclosure, Vol. 184, August 1979, Item 18431.

These radiographic films are typically processed after exposure to provide a black-and-white image using developing and fixing compositions that are known in the art.

Development is usually the first step to providing a useful black-and-white image in radiographic silver halide materials. Photographic black-and-white developing compositions containing a silver halide black-and-white developing agent are well known in the photographic art for reducing silver ions in silver halide grains containing a latent image to yield a developed black-and-white photographic image. Many useful developing agents are known in the art, with hydroquinone (and similar dihydroxybenzene compounds) and ascorbic acid (and ascorbic acid derivatives) being some of the most common. Such compositions generally contain other components such as sulfites, buffers, antifoggants, sequestering agents, halides, and hardeners.

The development step is generally followed by a fixing step in which a photographic fixing agent is used to remove silver halide from non-imaged areas of the radiographic film. Various inorganic and organic fixing agents are known for this purpose. In most instances, development and fixing are distinct steps as described in U.S. Pat. No. 6,040,121 (Fitterman et al.), but in some instances, development and fixing are combined as described in U.S. Pat. No. 6,074,806 (Fitterman et al.).

### PROBLEM TO BE SOLVED

Presently used radiographic silver halide films contain various silver halide emulsion layers coated on a transparent film support. This permits the developed images to be viewed using light boxes that provide backside illumination. The emulsions can be coated on both sides of the support. However, in some isolated and/or remote parts of the world, light boxes are not available, thereby severely limiting the usefulness of traditional radiographic films. In some of these locations, the ability of consultation and/or diagnosis may not be available. In addition, in some areas of the world, there is insufficient electrical power to generate X-radiation using traditional high-power imaging machines, or such machines are too heavy for convenient transport to remote sites.

Reflective films useful for radiography need to be able to perform a variety of X-ray exams. However, X-ray exams can be extremity imaging (skeletal) or chest imaging. A problem with designing a film for both of these exam types is that the imaging requirements for each exam type may be different. For example, in extremity imaging, a high contrast radiographic film may be desired. In chest imaging, to image the anatomy in the thoracic cavity (i.e. the lungs, heart, behind the diagram and the vertebral column) a lower contrast or wider exposure latitude radiographic film may be desired. Thus, there exists a need to design a reflective film that has a peak gamma of at least about 1.7 and a gamma of at least 50% of peak gamma over a 0.7 log E exposure range. A reflective film with a dynamic range of this magnitude would be desirable for imaging both chest and extremity exams. A peak gamma of 1.8 is more desirable; a peak gamma of 2.0 is even more desirable.

There is a need to find a means to provide radiographic imaging and diagnostics without the need for a light box. It would be useful if there were radiographic silver halide materials that could, imaged with low-power X-radiation equipment, and processed in a simple fashion to provide images viewable under ambient lighting. Reflective radiographic silver halide materials were developed to solve this problem as described in U.S. Pat. Nos. 7,014,977 (Dickerson et al.), 7,018,770 (Dickerson et al.), and 7,147,996 (Fitterman et al.). These patents describe the incorporation of developers within coatings of the photographic film. There is an additional need for simple and effective film constructions and developing compositions that contain reduced levels of various components, and methods of development of these films for use with reflective radiographic silver halide materials.

### SUMMARY OF THE INVENTION

In one embodiment the invention provides a radiographic silver halide film comprising a support that has first and second major surfaces, and having disposed on both major surfaces of the support, one or more hydrophilic colloid layers including a silver halide emulsion layer, the radiographic film also containing in one or more of the hydrophilic colloid layers on each side of the support, an incorporated black-and-white developing agent and a co-developing agent, the mole ratio of the developing agent to the silver in the silver halide emulsion being equal to or greater than about 0.25:1 and less than about 1.5:1.

In another embodiment, the invention provides, a radiographic silver halide film comprising a support that has first and second major surfaces, and having disposed on both major surfaces, one or more hydrophilic colloid layers including a silver halide emulsion layer, the radiographic film also containing in one or more of the hydrophilic colloid layers, an incorporated black-and-white developing agent and a co-developing agent, and wherein the developing agent is coated at from about 1 to 20 mg/dm².

In another embodiment, the invention provides a reflective radiographic silver halide film comprising a reflective support having first and second major surfaces, and having disposed only on the first major reflective support surface, one or more hydrophilic colloid layers including a silver halide emulsion layer, the radiographic film also containing in one or more of the hydrophilic colloid layers, an incorporated black-and-white developing agent and a co-developing agent, the mole ratio of the developing agent to the silver in the silver halide emulsion being equal to or greater than about 0.25:1 and less than about 0.7:1.

In yet another embodiment, the invention provides a reflective radiographic silver halide film comprising a reflective support having first and second major surfaces, the reflective radiographic film having disposed on only the first major reflective support surface, one or more hydrophilic colloid layers including a silver halide emulsion layer, the radiographic film also containing in one or more of the hydrophilic colloid layers, an incorporated black-and-white developing agent and a co-developing agent, and wherein the developing agent is coated at from about 1 to 20 mg/dm².

In still another embodiment, the invention provides a reflective radiographic film comprising a reflective support having first and second major surfaces, the reflective radiographic film having disposed on only the first major reflective support surface, one or more gelatin layers including a tabular silver halide emulsion layer and a protective gelatin overcoat layer, a hydroquinone (HQ) developer and a 4′-hydroxymethyl-4-methyl-1-phenyl-3-pyrazolidone (HMMP) co-developer, the silver halide being sensitized to blue or green light, the mole ratio of the developing agent to the silver in the silver halide emulsion being equal to or greater than about 0.25:1 and less than about 0.5:1, and wherein the first major surface of the reflective radiographic film has a matte finish.

In yet still another embodiment, the invention provides a reflective radiographic silver halide film comprising a reflective support having first and second major surfaces, the reflective radiographic film having disposed on the first major reflective support surface only, one or more gelatin layers including a tabular silver halide emulsion layer and a protective gelatin overcoat layer, a hydroquinone (HQ) developer and a 4′-hydroxymethyl-4-methyl-1-phenyl-3-pyrazolidone (HMMP) co-developer, the silver halide being sensitized to blue or green light, the coating weight of the developing agent in the silver halide emulsion being from about 3 to about 7 mg/dm², and wherein the first major surface of the reflective radiographic film has a matte finish.

In a further embodiment, the invention provides a method of providing a black-and-white image comprising:

(A) contacting an exposed black-and-white silver halide film containing an incorporated black-and-white developing agent and co-developing agent with an developer solution containing a black-and white developing and co-developing agent, the incorporated developing agent being present in an amount of from about 1 to about 20 mg/dm², and the developer being present in the developer solution in an amount of from about 1 to about 10 g/l, and

(B) contacting the exposed silver halide film with a solution comprising a fixing agent.

Typically, steps A) and B) are carried out sequentially for at least 30 and up to 90 seconds for each step. Steps A) and B) can be carried out sequentially for at least 30 and up to 120 seconds.

In a still further embodiment, the invention provides a radiographic kit comprising one or more black-and-white radiographic silver halide films comprising a support that has first and second major surfaces, the radiographic film having disposed on at least one support major surface, one or more hydrophilic colloid layers including a silver halide emulsion layer, the radiographic film also containing an incorporated black-and-white developing agent and co-developing agent in one or more of the hydrophilic colloid layers; one or more solutions of developer and co-developer; one or more solutions of fixer free of developer and co-developer, and optionally one or more phosphor screens sensitive to X-radiation.

In yet a further embodiment, the invention provides a radiographic kit comprising a radiographic silver halide film comprising a support that has first and second major surfaces, the radiographic film having disposed on at least one support major surface, one or more hydrophilic colloid layers including a silver halide emulsion layer, the radiographic film also containing an incorporated black-and-white developing agent in one or more of the hydrophilic colloid layers; a developer composition comprising of concentrations of less than 50 mmol/l of a primary developing agent, less than 2.5 mmol/l of a co-developing agent, and less than 0.075 mmol/l of an antifoggant (such a mercaptotetrazole compound) and having a pH of at less than 12; a fixing composition comprising less than 350 mmol/l of a fixing agent and less than 25 mmol/l of a hardening agent and having a pH in the range of 4.0 to 5.5, and a phosphor screen.

In yet a further embodiment, the invention provides a photographic developer solution comprising from about 2 to about 5 g/l of developer and from about 0.25 to about 1 g/l of co-developer.

Applicants have invented a method of processing silver halide materials that is simple, quick, and effective to provide black-and-white images. In particular, the method of processing can be used to provide radiographic images that can be viewed without a light box. More particularly, reflective radiographic silver halide materials containing incorporated black-and-white developing agents are processed using this invention.

The reduced amounts of developer in both the film and developer solution provides more consistent processing quality. In addition, the developer solution does not have to be replaced as often resulting in more efficient use of film processing chemicals. This is useful when development is carried out either using automated processing equipment or manually in a photographic laboratory.

### DETAILED DESCRIPTION OF THE INVENTION

In one embodiment, the radiographic film comprises a reflective support comprising on one surface; a silver halide emulsion layer and a protective overcoat layer. The silver halide layer comprises a hydrophilic polymer, a tabular silver halide grain emulsion, and a developer co-developer combination. Preferably the hydrophilic binder is gelatin. Preferably the emulsion is chemically sensitized with selenium, sulfur, and gold and spectrally sensitized with appropriate dye(s) to impart sensitivity to blue or green light. Preferably the developer is hydroquinone (HQ) and the co-developer is 4′-hydroxymethyl-4-methyl-1-phenyl-3-pyrazolidone (HMMP). The radiographic film is prepared by coating a reflective support with at least two layers, including an emulsion layer and an overcoat layer and is hardened, preferably with 3.5% bis(vinyl-sulfonyl)methane (BVSM), hardener. The support is a reflective support, and preferably a reflective paper support. Preferably, an X-ray intensifying screen is a prompt green-emitting X-ray intensifying screen and is in contact with the frontside (i.e., the emulsion coated and reflective side) of the film.

In another embodiment, the radiographic film comprises a transmissive support comprising on at least one surface; a silver halide emulsion layer and a protective overcoat layer. At least one silver halide layer comprises a hydrophilic polymer, a tabular silver halide grain emulsion, and a developer co-developer combination. The second surface of the support optionally comprises a silver halide layer that may comprise tabular grains or cubic grains. Preferably, the hydrophilic binder is gelatin. Preferably the emulsion is chemically sensitized with selenium, sulfur, and gold and spectrally sensitized with appropriate dye(s) to impart sensitivity to blue or green light. Preferably the developer is hydroquinone (HQ) and the co-developer is 4′-hydroxymethyl-4-methyl-1-phenyl-3-pyrazolidone (HMMP). The radiographic film is prepared by coating at least one surface of the transmissive support with at least two layers, including an emulsion layer and an overcoat layer and is hardened, preferably with 3.5% bis(vinylsulfonyl)methane (BVSM), hardener. When using a transparent support radiographic films having silver halide materials coated on both sides of the support are preferred. Such films are often referred to as “double-sided” or “duplitized” and have the same or different silver halide layers on both sides,

The amount of developer and co-developer in the film is a portion of the amount needed for full image development. The remainder of the developer and co-developer is contained in a developing solution. The use of a combination of a portion of development chemistry incorporated within the radiographic film and the remainder of the development chemistry in a developer solution permits the use of more dilute developer solution. This saves cost of shipping chemicals, and provides less chemistry to be disposed of after processing, thus resulting in environmental advantages. The particular developer and co-developer used in the film need not be the same as the particular developer and co-developer used in the developer solution. Mixtures of various developers and co-developers can also be used if desired.

There is another advantage to radiographic films having a portion of the developer chemistry incorporated within the radiographic film and having the remainder of the developer chemistry in the developer solution. During processing, some developer (e.g., hydroquinone; HQ), co-developer (e.g., 4′-hydroxymethyl-4-methyl-1-phenyl-3-pyrazolidone; HMMP), and other materials can diffuse out of the radiographic film. This provides a method of replenishing the developer solution chemistry. The concentration of developer components in film (developer and paper) can compensate for typical decrease of these components in the developer solution due to consumption and oxidation. As a result, a “steady-state” can be approached and the developer chemistry can be used for a longer period of time before it becomes exhausted and needs to be discarded. This provides further environmental advantages and cost savings.

### DEFINITIONS

The terms “a” or “an” refer to “at least one” of that component (for example, the ink jet inks, polymers, and surfactants described herein). Thus the term “an ink-receptive coating can refer to a coating capable of receiving one or more inks.

Unless otherwise noted, as used herein, the terms “developer,” “developing agent,” and “black-and-white developing agent” refer to the same chemical composition. Similarly, the terms “fixer,” “fixing agent,” and “black-and-white fixing agent” refer to the same chemical composition.

In the processing method of this invention, the embodiments refer to the use of sequential developing and fixing steps.

The term “processed materials” means the silver halide films that have been developed and fixed.

The term “lower scale contrast” (LSC) as herein employed refers to the average contrast derived from a characteristic curve of a radiographic film using as a first reference point (1) having a density (D₁) of 0.1+minimum density and point (2) a density (D₂) of 0.5 above minimum density, where lower scale contrast is the slope of the line drawn between these two density points. LSC is a measure of the ability of a film to detect faint anatomical features, particularly at lower densities such as when imaging bones in skeletal extremity imaging.

The term “mid-scale contrast” (MSC) as herein employed refers to the average contrast derived from a characteristic curve of a radiographic film using as a first reference point (1) having a density (D₁) of 0.5+minimum density and point (2) a density (D₂) of 1.5 above minimum density, where mid-scale contrast is the slope of the line drawn between these two density points. In some embodiments of this invention, MSC is a preferred measure of a film's ability to detect anatomical features.

The term “Gamma” is used to refer to the instantaneous rate of change of a density vs. log E (exposure) sensitometric curve (or instantaneous contrast at any log E value).

The term “Speed 1.0” is defined as the exposure needed to produce a net density of 1.0 above Dₘᵢₙ on the developed film.

The term “GF” refers to gross fog. Gross fog is the total density read at the lowest exposure step. It consists of density from the support and any density from silver fog.

The term “exposure range” is the difference in log E over a specified range (i.e., 0.7 log E) as described in the features below.

The term “dynamic range” refers to the difference between Dₘₐₓ and Dₘᵢₙ values on the Density vs. log E sensitometric curve at a specified exposure time. In the case of the data presented below in the Examples where the film is exposed to blue or green exposure light from a visible light source, the specified exposure time was 1/50 of a second. In the case of data presented below in the Examples where a screen/film assembly is exposed using an X-ray radiation source, the exposure time was 100 or 125 ms, and an X-ray fluorescent intensifying screen was used which converts this X-ray exposure into visible light exposure.

The term “contrast latitude” (CL) refers to the range of log E for which gamma is greater than or equal to 50% of the highest gamma value measured in the sensitometric curve between Dmin and Dmax.

The term “screen/film assembly” refers to the arrangement of the film in direct contact with one or two X-ray fluorescent intensifying screens such that the film is exposed to visible radiation from the screens produced by the X-ray exposure.

The term “UDP” refers to the upper density point, that is, the highest density measured.

In referring to grains and silver halide emulsions containing two or more halides, the halides are named in order of ascending molar concentrations.

The term “equivalent circular diameter” (ECD) is used to define the diameter of a circle having the same projected area as a silver halide grain. This can be measured using known techniques.

The term “aspect ratio” is used to define the ratio of grain ECD to grain thickness.

The term “coefficient of variation” (COV) is defined as 100 times the standard deviation (a) of grain ECD divided by the mean grain ECD.

The term “tabular silver halide grain” is any emulsion grain with an aspect ratio greater than 5.

The term “phosphor screen” refers to a fluorescent intensifying screen that absorbs X-radiation and promptly emits light immediately upon exposure to radiation while a “storage” screen or panel can “store” the exposing X-radiation for emission at a later time when the screen is irradiated with other radiation (usually visible light).

The terms “frontside” and “backside” of the film refer to the “first and second major surfaces” respectively. In the films described herein that are coated onto a reflective support, the emulsions are coated onto the frontside (first major surface) of the support. The frontside of the film is the reflective side.

The terms “front” and “back” refer to layers, films, or fluorescent intensifying screens nearer to and farther from, respectively, the source of X-radiation.

The term “punch through” refers to exposure of the frontside photosensitive emulsion layers by light emitted from the backside phosphor screen. “Punch through” exposure causes an unsharp image, and lower image quality of the radiograph. Reducing punch through improves image quality.

Research Disclosure is published by Kenneth Mason Publications, Ltd., The Book Barn, Westbourne, Hampshire, PO10 8RS, UK. The publication is also available from Research Disclosure, 145 Main Street, Ossining, N.Y. 10562 (www.researchdisclosure.com).

### Silver Halide Materials

The materials used in the practice of the present invention include any black-and-white silver halide materials comprising one or more silver halide emulsion layers and one or more “incorporated black-and-white developing agents” in one or more of those emulsion layers. Such black-and-white silver halide materials include commercial and consumer black-and-white films and papers, graphic arts films, black-and-white motion picture films, and especially radiographic films.

Examples of black-and-white papers and films that can be modified to include a developer incorporated within the emulsion layer or in an adjacent layer, and can be processed using the dilute developer solutions described herein include, but are not limited to, KODAK TRI-X-PAN Black and White Film, KODAK PLUS X-PAN Black and White Film, KODAK TMAX 100 and 400 speed Black and White Films, KODAK POLYMAX II RC Black and White Papers, KODAK KODABROME II RC F Black and White Paper, KODAK PMAX Art RC V Black and White Paper, KODAK POLYCONTRAST III RC Black and White Paper, KODAK PANALURE Select RC Black and White Paper, KODAK POLYMAX FINE ART Black and White Papers, KODAK AZO Black and White Papers, ILFORD MULTIGRADE IV RC and FB Black and White Papers, ILFORD ILFOBROME GALARIE Black and White Papers, and AGFA MULTICONTRAST CLASSIC, PREMIUM Black and White Papers.

In particular, the present invention is used to process radiographic films comprising the incorporated black-and-white developing agents described herein. More particularly, the radiographic films are “reflective radiographic films” that have a radiographic film speed of at least 100, preferably 200, more preferably between 200 and 400, and even more preferably greater than 400, include a reflective support (described below) having disposed on one side only, one or more photographic silver halide emulsion (hydrophilic colloid) layers and optionally one or more non-light sensitive hydrophilic colloid layer(s). Where there are multiple silver halide emulsion layers, their composition, thickness, and sensitometric properties can be the same or different. Preferably, there is a single silver halide emulsion layer on the reflective support.

In certain embodiments, the radiographic films have a single silver halide emulsion layer on one side of the reflective support and a protective overcoat (described below) over it and any other non-light sensitive layers. Thus, at least one non-light sensitive hydrophilic layer is included with the silver halide emulsion layer. This layer may be an interlayer or overcoat layer, or both types of non-light sensitive layers can be present. In additional embodiments, the radiographic films have a light absorbing layer to absorb light transmitted through the backside of the reflective support.

The radiographic films coated on a reflective support described herein are useful for a variety of X-ray examinations. However, some exams are either extremity imaging (skeletal) or chest imaging. A problem with designing a film for both of these exam types is that the imaging requirements for each are different. In extremity imaging, a high contrast radiographic film is desired. In chest imaging, to image the anatomy in the thoracic cavity (i.e. the lungs, heart, behind the diagram and the vertebral column) a lower contrast or wider exposure latitude radiographic film is desired. Thus, there exists a need to design reflective films that have a peak gamma of at least 1.7 and a gamma of at least 50% of peak gamma over at least a 0.7 log E exposure range. A reflective film with a dynamic range of this magnitude would be beneficial for imaging both chest and extremity exams. A peak gamma of 1.8 is more desirable; a peak gamma of 2.0 is even more desirable.

### The Silver Halide

The silver halide emulsion layer(s) preferably comprises tabular silver halide grains and can further include silver halide grains having any desirable morphology and halide composition or comprise a mixture of two or more of such morphologies and halide compositions as long as the desired photographic speed is achieved for the radiographic film. The composition and methods of making such silver halide grains are well known in the art. At least some of these grains are sensitized with materials known in the art to impart any desired photographic speed to the radiographic film in any desired wavelength region including UV, visible, and IR. At least some of the grains in the emulsion may contain internally-incorporated sensitizers and/or sensitometric modifiers, including dopants, known in the art.

Preferably, the one or more silver halide emulsion layers comprise predominantly (more than 50%, and preferably at least 70%, of the total grain projected area) tabular silver halide grains. The grain composition can vary among multiple silver halide emulsion layers, but preferably, the grain composition is essentially the same in all silver halide emulsion layers. These tabular silver halide grains generally comprise at least 50, preferably at least 90, and more preferably at least 95 mol % bromide, based on total silver in the particular emulsion layer. Such emulsions include silver halide grains composed of, for example, silver iodobromide, silver chlorobromide, silver iodochlorobromide, and silver chloroiodobromide. The iodide grain content is generally up to 5 mol %, based on total silver in the emulsion layer. Preferably the iodide grain content is up to 3 mol %, and more preferably up to about 1 mol % (based on total silver in the emulsion layer). The different halide atoms in the grains may be distributed evenly, or there may be regions more concentrated than the grain average yielding a non-uniform grain composition. Mixtures of different tabular silver halide grains can be used in the silver halide emulsion layers.

The tabular silver halide grains used in the silver halide emulsion layers generally have as aspect ratio of at least 5, preferably 25 or more, more preferably of 30 or more, and even up to 100. Tabular grains having an aspect ratio of from about 30 to about 50 are particularly useful. When multiple silver halide layers are used, the aspect ratio can be the same or different in multiple silver halide emulsion layers.

In general, the tabular grains have an average grain diameter (ECD) of at least 0.5 μm, and preferably from about 0.8 μm to about 6 μm, and more preferably from about 1 μm to about 4 μm. The average grain diameters can be the same or different in multiple silver halide emulsion layers. At least 100 tabular grains are measured to obtain the “average” ECD.

In addition, the tabular grains generally have an average thickness of from about 0.04 to about 0.25 μm, and preferably from about 0.06 to about 0.13 μm. The average thickness can be the same or different but preferably it is essentially the same for multiple silver halide emulsion layers.

A particularly useful tabular grain emulsion comprises tabular grains having an average grain diameter of from about 0.8 to about 5.0 μm, an average thickness of from about 0.04 to about 0.25 μm, and comprise at least 97 mol % bromide and up to 3 mol % iodide, both based on total halide within in the grains.

The procedures and equipment used to determine tabular grain size and aspect ratio are well known in the photographic art.

Tabular grain emulsions that have the desired composition and sizes are described in the following patents, the disclosures of which are incorporated herein by reference in relation to the tabular grains:

U.S. Pat. Nos. 4,414,310 (Dickerson), 4,425,425 (Abbott et al.), 4,425,426 (Abbott et al.), 4,439,520 (Kofron et al.), 4,434,226 (Wilgus et al.), 4,435,501 (Maskasky), 4,713,320 (Maskasky), 4,803,150 (Dickerson et al.), 4,900,355 (Dickerson et al.), 4,994,355 (Dickerson et al.), 4,997,750 (Dickerson et al.), 5,021,327 (Bunch et al.), 5,147,771 (Tsaur et al.), 5,147,772 (Tsaur et al.), 5,147,773 (Tsaur et al.), 5,171,659 (Tsaur et al.), 5,252,442 (Dickerson et al.), 5,370,977 (Zietlow), 5,391,469 (Dickerson), 5,399,470 (Dickerson et al.), 5,411,853 (Maskasky), 5,418,125 (Maskasky), 5,494,789 (Daubendiek et al.), 5,503,970 (Olm et al.), 5,536,632 (Wen et al.), 5,518,872 (King et al.), 5,567,580 (Fenton et al.), 5,573,902 (Daubendiek et al.), 5,576,156 (Dickerson), 5,576,168 (Daubendiek et al.), 5,576,171 (Olm et al.), and 5,582,965 (Deaton et al.).

A variety of silver halide dopants can be used, individually and in combination, in one or more of the silver halide emulsion layers to improve contrast as well as other common sensitometric properties. A summary of conventional dopants is provided in Research Disclosure, Item 38957 [Section I Emulsion grains and their preparation, sub-section D, and grain modifying conditions and adjustments are in paragraphs (3), (4), and (5)].

A general summary of silver halide emulsions and their preparation is provided in Research Disclosure, Item 38957 (Section I Emulsion grains and their preparation). After precipitation and before chemical sensitization the emulsions can be washed by any convenient conventional technique using techniques disclosed by Research Disclosure, Item 38957 (Section III Emulsion washing).

The emulsions can be chemically sensitized by any convenient conventional technique as illustrated by Research Disclosure, Item 38957 (Section IV Chemical Sensitization). Sulfur, selenium or gold sensitization (or any combination thereof) is specifically contemplated. Sulfur sensitization is preferred, and can be carried out using for example, thiosulfates, thiosulfonates, thiocyanates, isothiocyanates, thioethers, thioureas, cysteine, or rhodanine. A combination of gold and sulfur sensitization is most preferred.

In addition, if desired, the silver halide emulsions can include one or more suitable spectral sensitizing dyes that include, for example, cyanine and merocyanine spectral sensitizing dyes. The useful amounts of such dyes are well known in the art but are generally within the range of from about 200 to about 2,500 mg/mole of silver in the given emulsion layer. Single dyes or blends of different dye may be used. It is preferred that all of the silver halide grains used in the present invention (in all silver halide emulsion layers) be “green-sensitized” (generally, spectrally sensitized to radiation within the range of about 450 to about 600 nm of the electromagnetic spectrum) or “blue-sensitized” (generally, spectrally sensitized to radiation within the range of from about 350 to about 550 nm). Various spectral sensitizing dyes and sensitizing-dye combinations are known for achieving this property.

Instability that increases minimum density in negative-type emulsion coatings (i.e., fog) can be protected against by incorporation of stabilizers, antifoggants, antikinking agents, latent-image stabilizers, and similar addenda in the emulsion and contiguous layers prior to coating. Such addenda are illustrated in Research Disclosure, Item 38957 (Section VII Antifoggants and stabilizers) and Item 18431 (Section II Emulsion Stabilizers, Antifoggants and Antikinking Agents).

It may also be desirable that the silver halide emulsion layers include one or more covering power enhancing compounds adsorbed to surfaces of the silver halide grains. A number of such materials are known in the art, but preferred covering power enhancing compounds contain at least one divalent sulfur atom that can take the form of a —S— or ═S moiety. Such compounds are described in U.S. Pat. No. 5,800,976 (Dickerson et al.) that is incorporated herein by reference for the teaching of such sulfur-containing covering power enhancing compounds.

### Polymer Vehicles

The silver halide emulsion layers and other hydrophilic layers on the reflective support of the radiographic films generally include conventional polymer vehicles (peptizers and binders) that include both synthetically prepared and naturally occurring colloids or polymers. The most preferred polymer vehicles include gelatin or gelatin derivatives alone or in combination with other vehicles. Conventional gelatino-vehicles and related layer features are disclosed in Research Disclosure, Item 38957 (Section II Vehicles, vehicle extenders, vehicle-like addenda and vehicle related addenda). The emulsions themselves can contain peptizers of the type set out in Section II, paragraph A (Gelatin and hydrophilic colloid peptizers). The hydrophilic colloid peptizers are also useful as binders and hence are commonly present in much higher concentrations than required to perform the peptizing function alone. The preferred gelatin vehicles include alkali-treated gelatin, acid-treated gelatin, or gelatin derivatives (such as acetylated gelatin, deionized gelatin, oxidized gelatin, and phthalated gelatin). Cationic starch used as a peptizer for tabular grains is described in U.S. Pat. Nos. 5,620,840 (Maskasky) and 5,667,955 (Maskasky). Both hydrophobic and hydrophilic synthetic polymeric vehicles can be used also. Such materials include, but are not limited to, polyacrylates (including polymethacrylates), polystyrenes, polyacrylamides (including polymethacrylamides), and dextrans as described in U.S. Pat. No. 5,876,913 (Dickerson et al.), incorporated herein by reference.

### Silver Halide Emulsions

Thin, high aspect ratio tabular grain silver halide emulsions will typically be prepared by processes including nucleation and subsequent growth steps. During nucleation, silver and halide salt solutions are combined to precipitate a population of silver halide nuclei in a reaction vessel. Double jet (addition of silver and halide salt solutions simultaneously) and single jet (addition of one salt solution, such as a silver salt solution, to a vessel already containing an excess of the other salt) process are known. During the subsequent growth step, silver and halide salt solutions, and/or preformed fine silver halide grains, are added to the nuclei in the reaction vessel, and the added silver and halide combines with the existing population of grain nuclei to form larger grains. Control of conditions for formation of high aspect ratio tabular grain silver bromide and iodobromide emulsions is known, for example, based upon U.S. Pat. Nos. 4,434,226 (Wilgus et al.), 4,433,048 (Solberg et al.), and 4,439,520 (Kofron et al.). It is recognized, for example, that the bromide ion concentration in solution at the stage of grain formation must be maintained within limits to achieve the desired aspect ratio of grains. As grain growth continues, the bromide ion concentration in solution becomes progressively less influential on the grain shape ultimately achieved. For example, U.S. Pat. No. 4,434,226 (Wilgus et al.), for example, teaches the precipitation of high aspect ratio tabular grain silver bromoiodide emulsions at bromide ion concentrations in the pBr range of from 0.6 to 1.6 during grain nucleation, with the pBr range being expanded to 0.6 to 2.2 during subsequent grain growth. U.S. Pat. No. 4,439,520 (Kofron et al.) extends these teachings to the precipitation of high aspect ratio tabular grain silver bromide emulsions. pBr is defined as the negative log of the solution bromide ion concentration. U.S. Pat. No. 4,414,310 (Daubendiek et al.) describes a process for the preparation of high aspect ratio silver bromoiodide emulsions under pBr conditions not exceeding the value of 1.64 during grain nucleation. U.S. Pat. No. 4,713,320 (Maskasky), in the preparation of high aspect ratio silver halide emulsions, teaches that the useful pBr range during nucleation can be extended to a value of 2.4 when the precipitation of the tabular silver bromide or bromoiodide grains occurs in the presence of gelatino-peptizer containing less than 30 micromoles of methionine (for example, oxidized gelatin) per gram. The use of such oxidized gel also enables the preparation of thinner and/or larger diameter grains, and/or more uniform grain populations containing fewer non-tabular grains.

The use of oxidized gelatin as peptizer during nucleation, such as taught by U.S. Pat. No. 4,713,320 (noted above), is preferred for making thin, high aspect ratio tabular grain emulsions, employing either double or single jet nucleation processes. As gelatin employed as peptizer during nucleation typically will comprise a fraction of the total gelatin employed in an emulsion, the percentage of oxidized gelatin in the resulting emulsion may be relatively small, that is, at least 0.05% (based on total dry weight).

Thus it is preferred that the coated tabular grain silver halide emulsion layers comprise tabular silver halide grains dispersed in a hydrophilic polymeric vehicle mixture comprising at least 0.05% and preferably at least 0.1% of oxidized gelatin based on the total dry weight of hydrophilic polymeric vehicle mixture in the coated emulsion layer. The upper limit for the oxidized gelatin can vary, but in some arrangements, it is 1.5% based on the total dry weight of the hydrophilic polymer vehicle mixture. Preferably, from about 0.1 to about 1.5% (by dry weight) of the hydrophilic polymer vehicle mixture is oxidized gelatin.

It is also preferred that the oxidized gelatin be in the form of deionized oxidized gelatin but non-deionized oxidized gelatin can be used, or a mixture of deionized and non-deionized oxidized gelatins can be used. Deionized or non-deionized oxidized gelatin generally has the property of relatively lower amounts of methionine per gram of gelatin than other forms of gelatin. Preferably, the amount of methionine is from 0 to about 3 μmol of methionine, and more preferably from 0 to 1 μmol of methionine, per gram of gelatin. This material can be prepared using known procedures.

The remainder of the polymeric vehicle mixture can be any of the hydrophilic vehicles described above, but preferably it is composed of alkali-treated gelatin, acid-treated gelatin acetylated gelatin, or phthalated gelatin.

The silver halide emulsions containing the tabular silver halide grains described above can be prepared as noted using a considerable amount of oxidized gelatin (preferably deionized oxidized gelatin) during grain nucleation and growth, and then additional polymeric binder can be added to provide the coating formulation. The amounts of oxidized gelatin in the emulsion can be as low as 0.3 g per mole of silver and as high as 50 g per mole of silver in the emulsion. Preferably, the amount of oxidized gelatin in the emulsion is from about 1 to about 30 g per mole of silver.

The silver halide emulsion layers (and other hydrophilic layers) in the reflective radiographic films are generally fully hardened using one or more conventional hardeners, such as for example, bis(vinylsulfonyl)methane (BVSM), bis(vinylsulfonylmethyl)ether (BVSME) and bis(vinylsulfonylethyl)ether (BSEE). The amount of hardener on the one side of the support in one or more silver halide emulsion layers is generally at from at least about 0.25 to about 5%. A more useful hardener range is from at least about 1.5% to about 5%. A particularly useful amount of hardener is about 3.5%. These ranges and amounts are based on the total dry weight of the gelatin.

The levels of silver and polymer vehicle in the reflective radiographic film can vary in the various silver halide emulsion layers. In general, the total amount of silver on the imaging side of the reflective support is at least 5 and up to about 25 mg/dm² (preferably from about 8 to about 10 mg/dm²). In addition, the total coverage of polymer vehicle (all layers) on the imaging side of the reflective support is generally at least 20 and up to 55 mg/dm², and preferably from about 30 to about 50 mg/dm². These amounts refer to dry weights.

In a particularly useful embodiment, the coated dry weights of silver and gelatin are about 10.75 and about 36.50 mg/dm², respectively.

### Protective Overcoats

The light reflective and transmissive radiographic films generally include a surface protective overcoat disposed on the imaging side that typically provides for physical protection of the various layers underneath. The protective overcoat can be sub-divided into two or more individual layers. For example, protective overcoats can be sub-divided into surface overcoats and interlayers (between the overcoat and silver halide emulsion layers). In addition to vehicle features discussed above the protective overcoats can contain various addenda to modify the physical properties of the overcoats. Such addenda are described in Research Disclosure, Item 38957 (Section IX Coating physical property modifying addenda, A. Coating aids, B. Plasticizers and lubricants, C. Antistats, and D. Matting agents). Interlayers that are typically thin hydrophilic colloid layers can be used to provide a separation between the silver halide emulsion layers and the surface overcoats or between the silver halide emulsion layers. The overcoat may also include a blue toning dye or a tetraazaindene (such as 4-hydroxy-6-methyl-1,3,3a,7-tetraazaindene). The overcoat may contain a mercaptotetrazole compound to provide improved image tone. Such compounds are described in U.S. Pat. Nos. 6,342,338 (Verbeeck et al.), 6,737,228 (Elst et al.), and in European Patent Specification 1262824B1 (Elst et al.).

The protective overcoat is generally comprised of one or more hydrophilic colloid vehicles, chosen from among the same types disclosed above in connection with the emulsion layers.

### Incorporated Black-and-White Developing Agents

The reflective radiographic films include one or more “incorporated black-and-white developing agents” (or reducing agents) that are compounds that can act to reduce silver (I) ion to silver metal. Conventional black-and-white developing agents of this type include aminophenols, polyhydroxybenzenes [such as p-dihydroxybenezenes including hydroquinone (abbreviated herein as HQ) and its derivatives], ascorbic acid and its derivatives [see for example U.S. Pat. Nos. 5,236,816 (Purol et al.) and 5,738,979 (Fitterman et al.), both incorporated by reference], 3-pyrazolidinones, and phenylenediamines. Hydroquinone and its derivatives are preferred black-and-white developing agents. Exemplary hydroquinone derivatives include hydroquinone monosulfonate, 2-hydroxyhydroquinone, 2-methylhydroquinone, 2-methoxyhydroquinone, and 2,3-dichlorohydroquinone. Mixtures of black-and-white developing agents can be used if desired.

The quantity of black-and-white developing agent in the reflective radiographic film depends upon the silver content of silver halide emulsion layer in which it is located and the reducing agent “strength” of the developing agent. It can be located in the single silver halide emulsion layer, or in one or more of multiple silver halide emulsion layers. Generally, the molar ratio of developer to silver is equal to or greater than 0.25:1 and less than 1.5:1. Preferably the molar ratio is from about 0.25:1 to about 0.7:1. More preferably, the molar ratio of developer to silver is equal to or greater than 0.25:1 and less than or equal to 0.5:1

It can be useful to include one or more “co-developers” in one or more silver halide emulsion layers that may work in association with the black-and-white developing agent to enhance the development process. The co-developer is usually present in a smaller quantity than the black-and-white developing agent with a molar ratio of black-and-white developing agent to co-developer being from about 5 to about 50:1, and preferably from about 10:1 to about 30:1.

Useful co-developers include aminophenols [such as p-aminophenol, o-aminophenol, N-methylaminophenyl, 2,4-diaminophenol hydrochloride, N-(4-hydroxyphenyl)glycine, and ELON® (methyl-p-aminophenol sulfate)], 1-phenyl-3-pyrazolidones or phenidones [such as compounds described in U.S. Pat. No. 5,236,816 (noted above) including phenidone-A (1-phenyl-3-pyrazolidone), phenidone-B (1-phenyl-4,4′-dimethyl-3-pyrazolidone), dimezone-S (4′-hydroxymethyl-4-methyl-1-phenyl-3-pyrazolidone)], blocked phenidones, and other such compounds known in the art. A most preferred co-developer is 4′-hydroxymethyl-4-methyl-1-phenyl-3-pyrazolidone (abbreviated herein as HMMP).

A portion of the black-and-white developing agents and co-developers is incorporated into the film in the silver halide layer(s) or into an adjacent non-photosensitive layer using procedures known in the art. The remainder of the black-and-white developing agent and co-developers is contained in the developer solution. In one embodiment the developer is incorporated in the emulsion layer. In other embodiments the developer is incorporated in one or more other layer such as an interlayer or overcoat layer. In still further embodiments, portions of the developer may be incorporated in one or more of these layers.

TABLE I shows the range the principle primary active ingredients (PAI) as coated in radiographic films as well as a typical amount used in a coating formulation. Silver is in the form of a silver halide emulsion, HQ is hydroquinone developer, HMMP is the co-developer specified in TABLE I, and the sensitizing dye is the (SS-3) that imparts greens sensitivity to the emulsion.

TABLE I

| | Invention | Invention |
|---|---|---|
| | Primary Active | Primary Active |
| Coating Level | Ingredient-Typical | Ingredient-Range |
| Description | (mg/dm²) | (mg/dm²) |
| Silver | 10.75 | 2.50 to 50.0 |
| Gelatin | 49 | 3.0 to 60.0 |
| Hardener | 3.5% of gel | 0.25 to 5.0% |
| HQ (developer) | 5.85 | 1.0 to 20.0 |
| HMMP (co-developer) | 0.30 | 0.05 to 1.00 |
| Sensitizing Dye | 0.046 | 0.02 to 0.25 |
| Ratio HQ/HMMP | 20:1 (wt. ratio) | 5:1-50:1 |

### Additional Materials and Features:

Gloss can be a problem in viewing photographic images. In radiographic films, gloss can obscure visualization of anatomical information in the radiograph. Reducing film gloss improves image quality. To reduce gloss, reflective papers are often manufactured with a structured surface in order to provide the imaged material with a matte finish. This can be achieved, for example, by using an embossing wheel to emboss the surface of the paper support during paper manufacturing or to emboss the overcoat of finished coated film.

Alternatively, matting agents maybe added to one or more frontside layers. Matting agents usable in this invention, for example, include fine particles or beads of poly(methylmethacrylate) homopolymer, copolymers of methyl-methacrylate and methacrylic acid, organic compounds such as starch, and inorganic compound particles such as silica, titanium dioxide, strontium sulfate, and barium sulfate. The particle size is preferably about 0.6 to 10 μm, and more preferably about 1 to 5 μm. In addition, film transport has become a particular problem as processing machines have become more simple and lower in cost. When used in radiography, a matte finish lowers gloss and also improves film transport in processing machines. One particular reflective paper having a matte finish that can be used as a support for the radiographic films described herein is the paper used as a support for Kodak Professional Endura Paper.

The radiographic films described herein can encounter situations with poor safelight conditions. The result of handling a film in poorly maintained “darkrooms” is high fog and lower image quality. The addition of a red absorbing dye to one or more of the hydrophilic colloid layers on the emulsion side of the reflective support can significantly improve safelight handling. Such dyes are known in the art. An example of such a dye is shown below as (FD-1).

The reflective films described herein are can be formulated to have peak gamma of at least about 1.7 and a gamma of at least 50% of peak gamma over at least 0.7 log E exposure range. As noted above, reflective films with a dynamic range of this magnitude would provide one film useful for both chest and extremity exams. A peak gamma of 1.8 is more desirable; a peak gamma of 2.0 is even more desirable.

As noted above, the reflective radiographic films can be used in isolated and remote locations where consultation and/or diagnosis may not be available. The reflective radiographic films described herein can be scanned and digitized. Once scanned and digitized, the digital data can be transmitted to a remote location for reprinting and diagnosis. Because the density range of the reflective films described herein is relatively narrow (0.06 to 1.8 OD), the scanner used can be inexpensive and use a lower intensity light source than those used in expensive, high quality scanners. A density expansion algorithm can then be used to expand the reprinted image to the higher density ranges typically seen on soft copy or film printed images.

The various coated layers of radiographic films can also contain tinting dyes to modify the image tone to reflected light. These dyes are not decolorized during processing and may be homogeneously or heterogeneously dispersed in the various layers. Preferably, such non-bleachable tinting dyes are in one or more silver halide emulsion layers.

### The Reflective Support

In some embodiments, the radiographic films have a reflective support. The use of reflective supports eliminates the need for a transparent support for backside illumination using a light box. The reflective support allows the image to be viewed directly under ambient light. By “reflective,” it is meant a support having a composition or structural arrangement such that it reflects at least 70% of incident light (such from ambient outdoor or indoor light). Preferably, at least 80% of incident light is reflected by the support.

Various reflective supports can be used including those used for conventional photographic papers that comprise wood fibers or a cellulosic material that is generally coated with baryta or one or more resins or polymers (such as polyolefins). Either or both the coating or paper can contain various reflective pigments such as titanium dioxide, barium sulfate, zinc sulfate, and others known in the photographic color paper art, antioxidants, optical brighteners and fluorescent materials. Further details about reflective paper supports are provided in Research Disclosure, September 1996, Item 38957, paragraph XV and references cited therein.

The reflective support is preferably a resin-coated paper support containing a reflective pigment having the desired reflectivity for this invention. Particularly useful reflective supports are those used in Kodak Professional Endura Paper and Kodak Consumer Paper (type F or type N surface). It is also particularly useful that the reflective support contain an optical brightener to enhance image brightness when viewed outdoors during daylight. Optical brighteners are typically materials that absorb ultraviolet light and fluoresce by emitting blue light. This results in a “whiter” white that enhances the visualization of the reflective film.

Reflective radiographic silver halide materials are also described in U.S. Pat. Nos. 7,014,977 (Dickerson et al.), 7,018,770 (Dickerson et al.), and 7,147,996 (Fitterman et al.), the entire disclosure of which is incorporated herein by reference.

Reflective lenticular supports as described in U.S. Pat. Nos. 5,013,621 (Kistner et al.) and 5,075,204 (Shiba et al.) can also be used.

Pigmented polymer supports can also be used including pigmented polyesters, pigmented polystyrene, and pigmented polycarbonates.

In addition, a reflective support can be a single- or multi-layer reflective sheet that is a reflective substrate comprising a “microvoided” continuous polyester first phase and a second phase dispersed within the continuous polyester first phase. This second phase comprises microvoids containing barium sulfate particles.

The continuous polyester first phase of the reflective support provides a matrix for the other components of the reflective support and is transparent to longer wavelength electromagnetic radiation. This polyester phase can comprise a film or sheet of one or more thermoplastic polyesters, which film has been biaxially stretched (that is, stretched in both the longitudinal and transverse directions) to create the microvoids therein around the barium sulfate particles. Any suitable polyester can be used as long as it can be cast, spun, molded, or otherwise formed into a film or sheet, and can be biaxially oriented as noted above. Generally, the polyesters have a glass transition temperature of from about 50 to about 150° C. (preferably from about 60 to about 100° C.) as determined using a differential scanning calorimeter (DSC). Suitable polyesters include those produced from the reaction of aromatic, aliphatic, or carbocyclic dicarboxylic acids of 4 to 20 carbon atoms and aliphatic or aromatic glycols having 2 to 24 carbon atoms.

Suitable polyesters that can be used in the practice of this invention include, but are not limited to, poly(1,4-cyclohexylene dimethylene terephthalate), poly(ethylene terephthalate), poly(1,3-cyclohexylene dimethylene terephthalate), and poly(ethylene naphthalate). Poly(1,4-cyclohexylene dimethylene terephthalate) is most preferred.

The ratio of the refractive index of the continuous polyester first phase to the second phase is from about 1.4:1 to about 1.6:1.

Barium sulfate particles are incorporated into the continuous polyester phase. These particles generally have an average particle size of from about 0.3 to about 2 μm (preferably from about 0.7 to about 1.0 μm). In addition, these particles comprise from about 35 to about 65 weight % (preferably from about 55 to about 60 weight %) of the total dry reflective substrate weight, and from about 15 to about 25% of the total reflective substrate volume.

The barium sulfate particles can be incorporated into the continuous polyester phase by various means. For example, they can be incorporated during polymerization of the dicarboxylic acid(s) and polyol(s) used to make the continuous polyester first phase. Alternatively and preferably, the barium sulfate particles are mixed into pellets of the polyester and the mixture is extruded to produce a melt stream that is cooled into the desired sheet containing barium sulfate particles dispersed therein.

These barium sulfate particles are at least partially bordered by voids because they are embedded in the microvoids distributed throughout the continuous polyester first phase. Thus, the microvoids containing the barium sulfate particles comprise a second phase dispersed within the continuous polyester first phase. The microvoids generally occupy from about 35 to about 60% (by volume) of the dry reflective substrate.

The microvoids can be of any particular shape, that is circular, elliptical, convex, or any other shape reflecting the film orientation process and the shape and size of the barium sulfate particles. The size and ultimate physical properties of the microvoids depend upon the degree and balance of the orientation, temperature, and rate of stretching, crystallization characteristics of the polyester, the size and distribution of the barium sulfate particles, and other considerations that would be apparent to one skilled in the art. Generally, the microvoids are formed when the extruded sheet containing barium sulfate particles is biaxially stretched using conventional orientation techniques.

Further details about such “microvoided” supports are provided in U.S. Pat. No. 7,029,819 (Laney et al.).

Still other reflective supports can be similarly prepared using a “microvoided” poly(lactic acid) instead of a “microvoided” polyester as described in U.S. Pat. No. 6,836,606 (Laney et al.).

The reflective support can have a thickness (dry) of from about 150 to about 190 μm (preferably from about 170 to about 190 μm).

### The Transmissive Support:

The radiographic films may comprise a polymeric support that is typically a flexible, transparent film that has any desired thickness and is composed of one or more polymeric materials. They are required to exhibit dimensional stability during development and to have suitable adhesive properties with overlying layers. Useful polymeric materials for making such supports include polyesters [such as poly(ethylene terephthalate) and poly(ethylene naphthalate)], cellulose acetate and other cellulose esters, polyvinyl acetal, polyolefins, polycarbonates, and polystyrenes. Useful supports are composed of polymers having good heat stability, such as polyesters and polycarbonates. Support materials may also be treated or annealed to reduce shrinkage and promote dimensional stability.

Also useful are transparent, multilayer, polymeric supports comprising numerous alternating layers of at least two different polymeric materials as described in U.S. Pat. No. 6,630,283 (Simpson et al.). Another support comprises dichroic mirror layers as described in U.S. Pat. No. 5,795,708 (Boutet). The disclosures of both of these patents are incorporated herein by reference.

Support materials can contain various colorants, pigments, antihalation or acutance dyes if desired. For example, the support can include one or more dyes that provide a blue color in the resulting imaged film. Support materials may be treated using conventional procedures (such as corona discharge) to improve adhesion of overlying layers, or subbing or other adhesion-promoting layers can be used.

### Phosphor Screens

A reflective radiographic film and a phosphor screen can be arranged in a suitable “cassette” designed for this purpose. Fluorescent intensifying screens are typically designed to absorb X-rays and to promptly emit electromagnetic radiation having a wavelength greater than 300 nm. These screens can take any convenient form providing they meet all of the usual requirements for use in radiographic imaging. Examples of conventional, useful fluorescent intensifying screens and methods of making them are provided in Research Disclosure, Item 18431 (Section IX X-Ray Screens/Phosphors) and U.S. Pat. Nos. 5,021,327 (Bunch et al.), 4,994,355 (Dickerson et al.), 4,997,750 (Dickerson et al.), and 5,108,881 (Dickerson et al.), the disclosures of which are here incorporated by reference. The fluorescent layer contains prompt-emitting phosphor particles dispersed in a suitable binder, and may also include a light scattering material, such as titania.

It is also contemplated to use ultraviolet emitting intensifying screens in conjunction with silver halide emulsions containing a relatively high iodide content (>3 mol %) and sensitized with short wavelength blue sensitizing dyes.

Any prompt-emitting phosphor can be used, singly or in mixtures, in the intensifying screens. The phosphors can be either blue-light or green-light emitting phosphors. For example, useful phosphors are described in numerous references relating to fluorescent intensifying screens, including but not limited to, Research Disclosure, Vol. 184, August 1979, Item 18431 (Section IX X-ray Screens/Phosphors) and U.S. Pat. Nos. 2,303,942 (Wynd et al.), 3,778,615 (Luckey), 4,032,471 (Luckey), 4,225,653 (Brixner et al.), 3,418,246 (Royce), 3,428,247 (Yocon), 3,725,704 (Buchanan et al.), 2,725,704 (Swindells), 3,617,743 (Rabatin), 3,974,389 (Ferri et al.), 3,591,516 (Rabatin), 3,607,770 (Rabatin), 3,666,676 (Rabatin), 3,795,814 (Rabatin), 4,405,691 (Yale), 4,311,487 (Luckey et al.), 4,387,141 (Patten), 4,021,327 (Bunch et al.), 4,865,944 (Roberts et al.), 4,994,355 (Dickerson et al.), 4,997,750 (Dickerson et al.), 5,064,729 (Zegarski), 5,108,881 (Dickerson et al.), 5,250,366 (Nakajima et al.), and 5,871,892 (Dickerson et al.), and EP 0 491,116A1 (Benzo et al.), the disclosures of all of which are incorporated herein by reference with respect to the phosphors.

The inorganic phosphor can be calcium tungstate, activated or unactivated lithium stannates, niobium and/or rare earth activated or unactivated yttrium, lutetium, or gadolinium tantalates, rare earth (such as terbium, lanthanum, gadolinium, cerium, and lutetium)-activated or unactivated middle chalcogen phosphors such as rare earth oxychalcogenides and oxyhalides, and terbium-activated or unactivated lanthanum and lutetium middle chalcogen phosphors.

Still other useful phosphors are those containing hafnium as described in U.S. Pat. Nos. 4,988,880 (Bryan et al.), 4,988,881 (Bryan et al.), 4,994,205 (Bryan et al.), 5,095,218 (Bryan et al.), 5,112,700 (Lambert et al.), 5,124,072 (Dole et al.), and 5,336,893 (Smith et al.), the disclosures of which are all incorporated herein by reference.

Alternatively, the inorganic phosphor is a rare earth oxychalcogenide and oxyhalide phosphors and represented by the following formula (1):

M′_{(w-n)}M″ₙO_{w}X′ (1)

wherein M′ is at least one of the metals yttrium (Y), lanthanum (La), gadolinium (Gd), or lutetium (Lu), M″ is at least one of the rare earth metals, preferably dysprosium (Dy), erbium (Er), europium (Eu), holmium (Ho), neodymium (Nd), praseodymium (Pr), samarium (Sm), tantalum (Ta), terbium (Tb), thulium (Tm), or ytterbium (Yb), X′ is a middle chalcogen (S, Se, or Te) or halogen, n is 0.002 to 0.2, and w is 1 when X′ is halogen or 2 when X′ is a middle chalcogen. These include rare earth-activated lanthanum oxybromides, and terbium-activated or thulium-activated gadolinium oxides or oxysulfides (such as Gd₂O₂S:Tb).

Other suitable phosphors are described in U.S. Pat. Nos. 4,835,397 (Arakawa et al.) and 5,381,015 (Dooms), both incorporated herein by reference, and include for example divalent europium and other rare earth activated alkaline earth metal halide phosphors and rare earth element activated rare earth oxyhalide phosphors. Of these types of phosphors, the more preferred phosphors include alkaline earth metal fluorohalide prompt emitting phosphors such as barium fluorobromide.

Another class of useful phosphors includes rare earth hosts such as rare earth activated mixed alkaline earth metal sulfates such as europium-activated barium strontium sulfate.

Other useful phosphors are alkaline earth metal phosphors that can be the products of firing starting materials comprising optional oxide or a combination of species as characterized by the following formula (2):

MFX_{1-z}I_{z}uM^{a}X^{a}:yA:eQ:tD (2)

wherein “M” is magnesium (Mg), calcium (Ca), strontium (Sr), or barium (Ba), “F” is fluoride, “X” is chloride (Cl) or bromide (Br), “I” is iodide, M^{a} is sodium (Na), potassium (K), rubidium (Rb), or cesium (Cs), X^{a} is fluoride (F), chloride (Cl), bromide (Br), or iodide (I), “A” is europium (Eu), cerium (Ce), samarium (Sm), or terbium (Tb), “Q” is BeO, MgO, CaO, SrO, BaO, ZnO, Al₂O₃, La₂O₃, In₂O₃, SiO₂, TiO₂, ZrO₂, GeO₂, SnO₂, Nb₂O₅, Ta₂O₅, or ThO₂, “D” is vanadium (V), chromium (Cr), manganese (Mn), iron (Fe), cobalt (Co), or nickel (Ni). The numbers in the noted formula are the following: “z” is 0 to 1, “u” is from 0 to 1, “y” is from 1×10⁻⁴ to 0.1, “e” is form 0 to 1, and “t” is from 0 to 0.01. These definitions apply wherever they are found in this application unless specifically stated to the contrary. It is also contemplated that “M”, “X”, “A”, and “D” represent multiple elements in the groups identified above.

The phosphor can be dispersed in a suitable binder(s) in a phosphor layer. A particularly useful binder is a polyurethane binder such as that commercially available under the trademark Permuthane.

The green fluorescent intensifying screens useful in this invention exhibit a photographic “screen” speed of at least 100 and preferably of at least 400. One preferred green-light emitting phosphor is a terbium activated gadolinium oxysulfide. The blue fluorescent intensifying screens useful in this invention exhibit a photographic “screen” speed of at least 100, preferably 200 and most preferably 400 speed. Preferred blue-light emitting phosphors include calcium tungstate and preferably rare-earth barium fluorobromide. A skilled worker in the art would be able to choose the appropriate inorganic phosphor, its particle size, emission wavelength, and coverage in the phosphor layer to provide the desired screen speed.

Support materials for fluorescent intensifying screens include cardboard, plastic films such as films of cellulose acetate, polyvinyl chloride, polyvinyl acetate, polyacrylonitrile, polystyrene, polyester, polyethylene terephthalate, polyamide, polyimide, cellulose triacetate and polycarbonate, metal sheets such as aluminum foil and aluminum alloy foil, ordinary papers, baryta paper, resin-coated papers, pigmented papers containing titanium dioxide or the like, and papers sized with polyvinyl alcohol or the like. A flexible plastic film is preferably used as the support material.

In addition, the screen support can be a “microvoided support” as described in more detail in U.S. Pat. Nos. 6,836,606 and 7,029,819 noted above.

The screen support may contain a light-absorbing material such as carbon black, or may contain a light-reflecting material such as titanium dioxide or barium sulfate. The former is appropriate for preparing a high-resolution type radiographic screen, while the latter is appropriate for preparing a high-sensitivity screen. It is preferred that the support absorbs substantially all of the radiation emitted by the phosphor. Examples of preferred screen supports include polyethylene terephthalate, blue colored or black colored (for example, LUMIRROR C, type X30 supplied by Toray Industries, Tokyo, Japan). These screen supports may have a thickness that may differ depending o the material of the support, and may generally be between about 60 and 1000 μm, more preferably between about 80 and 500 μm from the standpoint of handling.

### Imaging Conditions

The exposure of black-and-white materials (including radiographic films) can be undertaken in any convenient manner. The exposure techniques of U.S. Pat. Nos. 5,021,327 (Bunch et al.) and 5,576,156 (Dickerson) are typical for radiographic films. In operation, a radiographic film is generally included in an imaging assembly that also includes one or more fluorescent intensifying screens in front or back of the radiographic film. The radiographic film and front and back screens are usually mounted in direct contact in a suitable cassette. X-radiation in an imagewise pattern is passed through and partially absorbed in the front intensifying screen, and a portion of the absorbed X-radiation is re-emitted as a visible light image that exposes the silver halide emulsion units of the radiographic film. For the reflective radiographic silver halide materials described above, a single “frontside” screen is preferably used for imaging. For the duplitized silver halide materials coated onto a transparent support, frontside and backside screens are useful.

It is noted that an imaging assembly comprising the reflective radiographic film and a screen has sufficiently high photographic speed that they can be imaged using “low power” and less expensive X-radiation generators. Generally, such X-radiation generators have relatively low, fixed X-radiation tube currents in the range of from about 15 to about 20 milliAmperes (mA) and peak 100-130 kVp voltage, preferably also used combination with an anti-X-ray scatter grid with a grid ratio of 8:1 or higher. In contrast, the typical “fixed installation” high-powered X-radiation generating systems produce 500-1000 mA enabling very short (5-40 milliseconds) patient exposure times for motion-sensitive imaging such as chest radiography.

### Developer Solution Compositions and Methods

The present invention is useful for providing black-and-white images in any black-and-white photographic silver halide material containing an incorporated black-and-white developing agent (described below). Such photographic silver halide materials include, but are not limited to, radiographic films, aerial films, black-and-white motion picture films, duplicating and copy films, graphic arts films, positive- and negative-working microfilms, and amateur and professional continuous tone black-and-white films. The general compositions of such materials are well known in the art. This invention is particularly useful for providing black-and-white images in reflective radiographic silver halide materials described in more detail below.

The developer solution generally contains two developing agents. A “primary developing agent” is used herein to mean any compound present in a higher relative concentration that is capable of reacting with a silver ion to form metallic silver. Such developing agents include such compounds as aminophenols, polyhydroxybenzenes (such as p-dihydroxybenezenes including hydroquinone and its derivatives), 3-pyrazolidinones, ascorbic acid and its derivatives, and phenylenediamines, and well as other compounds that would be apparent to one skilled in the art. A “secondary developing agent” or “co-developer” as used herein means any developer compound present in a lower relative concentration that is capable of reacting with a silver ion to form metallic silver. Examples include, but are not limited to, phenypyrazolidone and related compounds.

The developing agents are present in the developer solution at a level optimized for the developer incorporated within the radiographic film to ensure consistent and uniform density. In general, the developer is present in the developer solution in an amount of less than about 5 g/l (45 mmol/l). Useful amounts of developer range from about 1 to about 10 g/l. More useful amounts of developer range from about 1 to about 5 g/l. More useful amounts of developer range from about 2 to about 5 g/l. Still more useful to use hydroquinone as the primary developer in an amount of from about 2 to about 5 g/l.

The co-developer is present in the developer solution in an amount of less than about 1 g/l. A more useful amount of co-developer is from about 0.25 to about 1 g/l. It is particularly useful to use 4′-hydroxymethyl-4-methyl-1-phenyl-3-pyrazolidone as the co-developer in an amount of from about 0.25 to about 0.5 g/l. Thus, useful amounts of co-developer range from about from about 1 to about 5 mmol/l.

The developer solution generally contains an “antifogging agent”. As used herein, “antifogging agent” or “antifoggant” means any compound that is capable of restraining or controlling development of silver ions to form metallic silver. Examples include, but are not limited to, mercaptotetrazoles, indazoles, benzotriazoles, and other heterocyclic amine compounds. The antifoggant is present at a level optimized for the film with incorporated developer to ensure low Dₘᵢₙ and high contrast and Dₘₐₓ.

The developer solution generally has a pH of at less than 12, preferably at least 10, and more preferably at least 10.5. The alkalinity of this solution and the presence of sulfite ions “activates” the incorporated developer in the processed material. Alkalinity can be assured by addition of suitable amounts of one or more bases to the solution. Particularly useful bases are hydroxides such as sodium hydroxide and potassium hydroxide.

The developer solution generally also contains one or more sulfites. A “sulfite” is used herein to mean any sulfur compound that is capable of forming or providing sulfite ions in aqueous alkaline solution. Examples include, but are not limited to, alkali metal sulfites, alkali metal bisulfites, alkali metal metabisulfites, amine sulfur dioxide complexes, sulfurous acid, and carbonyl-bisulfite adducts. Mixtures of these materials can also be used.

Examples of preferred sulfites include sodium sulfite, potassium sulfite, lithium sulfite, sodium bisulfite, potassium bisulfite, potassium metabisulfite, sodium metabisulfite, and lithium metabisulfite. The carbonyl-bisulfite adducts that are useful include alkali metal or amine bisulfite adducts of aldehydes and bisulfite adducts of ketones. Examples of these compounds include sodium formaldehyde bisulfite, sodium acetaldehyde bisulfite, succinaldehyde bis-sodium bisulfite, sodium acetone bisulfite, β-methyl glutaraldehyde bis-sodium bisulfite, sodium butanone bisulfite, and 2,4-pentandione bis-sodium bisulfite.

One or more sulfites are present in the developer solution in an amount sufficient to provide at least 100 mmol/l of sulfite ions, and preferably from about 200 mol/l to about 700 mmol/l of sulfite ions. Various sulfites are readily available from a number of commercial sources.

The developer solution can also contain one or more sequestering agents that typically function to form stable complexes with free metal ions or trace impurities (such as silver, calcium, iron, and copper ions) in solution that may be introduced into the developing composition in a number of ways. The sequestering agents, individually or in admixture, are present in conventional amounts. Many useful sequestering agents are known in the art, but particularly useful classes of compounds include, but are not limited to, multimeric carboxylic acids, polyphosphonic acids and polyaminophosphonic acids, and any combinations of these classes of materials as described in U.S. Pat. No. 5,389,502 (Fitterman et al.), aminopolycarboxylic acids and polyphosphate ligands. Representative sequestering agents include ethylenediaminetetraacetic acid (“EDTA”), diethylenetriaminepentaacetic acid (“DTPA”), 1,3-propylenediamine-tetraacetic acid (“PDTA”), 1,3-diamino-2-propanoltetraacetic acid (“DPTA”), ethylenediaminodisuccinic acid (“EDDS”), ethylenediaminomonosuccinic acid (“EDMS”), 4,5-dihydroxy-1,3-benzenedisulfonic acid, disodium salt (TIRON™), N,N′-1,2-ethanediylbis{N-[(2-hydroxyphenyl)methyl]}glycine (“HBED”), N-{2-[bis(carboxymethyl)-amino]ethyl}-N-(2-hydroxyethyl)glycine (“HEDTA”), N-{2-[bis(carboxymethyl)-amino]ethyl}-N-(2-hydroxyethyl)glycine, trisodium salt (available as VERSENOL™ from Acros Organics, Sigma Chemical or Callaway Chemical), and 1-hydroxyethylidenediphosphonic acid (available as DEQUEST™ 2010 from Solutia Co.). These compounds can be used in free acid or salt form and are usually present in an amount of from about 7.5 to about 15.0 mmol/l.

The developer solution can also contain other additives including various development restrainers, development accelerators, swelling control agents, dissolving aids, surface active agents, colloid dispersing aids, restrainers (such as sodium or potassium bromide), and sludge control agents (such as 2-mercaptobenzothiazole, 1,2,4-triazole-3-thiol, 2-benzoxazolethiol and 1-phenyl-5-mercatotetrazole), each in conventional amounts. Examples of such components are described in U.S. Pat. Nos. 5,236,816 (noted above), 5,474,879 (Fitterman et al.), and 5,837,434 (Roussilhe et al.), Japanese Kokai 7-56286, and EP 0 585 792A1.

Because a portion of the developer and co-developer incorporated in the radiographic film, these additional components can be present in lower concentrations in the developer solution than in conventional developer solutions.

Developer solutions were prepared containing the materials shown below in TABLE II. The column labeled “Comparative” represents a typical commercially available “full strength” developer solution formulation for a radiographic films that do not contain a developer within the radiographic film. The inventive developer solution represents a typical developer solution formulation for use with radiographic films that contain developer within the radiographic film. It should be noted that a the inventive developer solution contains only about 12.5 wt % of hydroquinone developer used in commercially available developer solutions.

TABLE II

| | Developer Solution | | |
|---|---|---|---|
| | Comparative | Inventive | Inventive |
| | Developer | Developer | Developer |
| | Solution | Solution | Solution |
| Compound Name | g/l | g/l | Range g/l |
| Potassium bromide | 1.2 | 0.3 | 0 to 4 |
| Sodium pentetic acid | 3.4 | 0.8 | 0 to 5 |
| Potassium hydroxide | 35.2 | 6.8 | 3 to 30 |
| Disodium EDTA | 1.0 | 0.3 | 0 to 2 |
| Sodium metabisulfite, anhydrous | 68.7 | 18.7 | 9 to 70 |
| Potassium carbonate | 12.7 | 3.2 | 1.5 to 12 |
| 1-Phenyl-5-mercaptotetrazole | 0.025 | 0.013 | at least |
| (PMT)) | | | 0.013 |
| Diethylene glycol | 7.5 | 1.9 | 1.5 to 7.5 |
| 4′-Hydroxymethyl-4-methyl- | 2.0 | 0.25 | 0.2 to 0.5 |
| 1-phenyl-3-pyrazolidone (HMMP) | | | |
| Hydroquinone (HQ) (photograde) | 19.0 | 2.38 | 1 to 10 |

### Fixing Compositions and Methods

The primary photographic fixing agents used in this invention are compounds other than sulfites. Primary fixing agents include thiosulfates (including sodium thiosulfate, ammonium thiosulfate, potassium thiosulfate, and others readily known in the art). Other known fixing agents include thiol- or mercapto-containing compounds or disulfides (such as D-, L-, or D,L-cysteine, cysteine hydrochloride, homocysteine, methionine, cystine, thiourea, 2-amino-ethanethiol, 2-amino-ethanethiol hydrochloride, 3-amino-propanethiol, mercaptopyridine, and others described by Haist, Modern Photographic Processing, John Wiley & Sons, N.Y., Vol. I, 1979), mercapto acids (such as mercaptosuccinic acid, mercaptoacetic acid, thiosalicylic acid and others described in the noted Haist reference, pp. 602-605 and by Mason, Photographic Processing Chemistry, Chapter VI, p. 198) and thiocyanates (such as sodium thiocyanate, potassium thiocyanate, ammonium thiocyanate and others readily known in the art as described in the noted Haist reference, p. 596ff and Mason reference, p. 197). Mixtures of one or more fixing agents, including combinations of those in one or more of these classes of photographic fixing agents can be used if desired. By “thiol-containing”, it is meant a compound having an —SR group, wherein R is hydrogen or methyl. Additional useful fixing agents are the sulfur-containing compounds defined by Structures I, II, III, and IV in U.S. Pat. No. 6,623,915 (Haye et al.) that is incorporated herein by reference for those sulfur-containing compounds. Sulfites, such as sodium and/or potassium sulfite can be used with primary fixing agents.

The fixing agent is present in the fixing agent solution in an amount of less than about 50 g/l. Useful amounts of fixing agent range from about from about 100 to 350 mmol/l. A suitable amount of fixing agent is from about 15 to about 50 g/l. In some embodiments of this invention, the thiosulfates are preferred fixing agents. It may be desired to use ammonium and/or sodium thiosulfate as the fixing agent in an amount of from about 15 to about 40 g/l.

The fixing agent compositions used in the embodiments can also include one or more sequestering agents (as defined above), sulfites (as preservatives rather than as fixing agents), buffers, fixing accelerators, swelling control agents, and stabilizing agents, each in conventional amounts. In its aqueous form, the fixing composition generally has a pH of at least 4, preferably at least 4.5, and generally less than about 6. A pH of from about 4.0 to 5.5 is preferred.

Fixing agent solutions were prepared containing the materials shown below in TABLE III. The column labeled “Comparative” represents a typical fixing agent solution formulation for radiographic films that do not contain developer within the radiographic film. The inventive fixing agent solution represents a typical fixing agent solution formulation for use with radiographic films that contain developer within the radiographic film.

TABLE III

| | Fixing agent Solution | | |
|---|---|---|---|
| | Comparative | Invention | Invention |
| | Fixing Agent | Fixing Agent | Fixing |
| | Solution | Solution | Agent Solution |
| Compound Name | g/L | g/L | Range g/l |
| Potassium hydroxide | 4.1 | 0.9 | 0.0 to 10 |
| Sodium Hydroxide | — | — | 0.0 to 10 |
| Acetic acid | 12.0 | 3.0 | 0.0 to 10 |
| Ammonium thiosulfate | 125.4 | 31.4 | 15 to 50 |
| Sodium sulfite | 11.0 | 2.8 | 1 to 10 |
| Sodium tetraborate (5 mole) | 5.50 | 1.38 | 0.0 to 5 |
| Aluminum sulfate | 4.1 | 2.0 | 0.0 to 5 |
| Tartaric acid | 1.9 | 0.9 | 0.0 to 5 |

As noted above, black-and-white developing agents are not present within the compositions containing the fixing agents.

Processing can be carried out in any suitable processor or processing container for a given type of photographic material (for example, sheets, strips or rolls). The photographic material is generally bathed in the processing compositions for a suitable period of time.

The development and fixing steps are preferably, but not essentially, followed by a suitable washing step to remove silver salts dissolved by fixing and excess fixing agents, and to reduce swelling in the film. The wash solution can be water, Washing can be carried out for any suitable length of time, but generally from about 30 to about 90 seconds is sufficient.

After washing, the processed materials may be dried using suitable times and temperature.

### Radiographic Kits:

The processing compositions described and used for this invention can be suitably packaged in individual bottles, packets, syringes, or other containers known in the art and sold together in a “kit” along with instructions for use and/or measuring devices. Radiographic kits can also include one or more radiographic films containing incorporated developers including the reflective radiographic films described herein, and/or phosphor screens, as well as solutions of developer and fixer.

The following examples are provided to illustrate the practice of the invention but the invention is not to be interpreted as limited by the examples.

### Materials and Methods for the Experiments and Examples

All materials used in the following examples are available from standard commercial sources, such as Aldrich Chemical Co. (Milwaukee Wis.) unless otherwise specified. All percentages are by weight unless otherwise indicated.

Some of the chemical components used herein are provided as a solution. The term “active ingredient” means the amount or the percentage of the desired chemical component contained in a sample. All amounts listed herein are the amount of active ingredient added unless otherwise specified. All coating weights refer to the dried films unless otherwise specified.

The following additional methods and materials were used.

Gloss 20 is the measured gloss of a film sample. Gloss was measured using a Gardner Glossmeter measured at an angle of 20 degrees from incidence.

GWN Copolymer is a latex copolymer of methylmethacryalte and butylmethacrylate [CAS 63149-50-8]. It was obtained from Eastman Kodak Co. (Rochester, N.Y.).

PIE Paper is the paper used in Kodak Professional Endura paper.

CIF paper is the paper used in Kodak Consumer F paper. This paper contains optical brighteners.

TRITON® X-200E surfactant is available from Dow Chemical Co. (Midland, Mich.).

Oxiranemethanol, polymer with nonylphenol is a surfactant. Additional names for this material are p-isononyl-phenoxypoly(glycidol) and Olin 10G surfactant.

Lanex Regular Screens are high quality rare-earth green emitting terbium activated, gadolinium oxysulfide X-ray screens. Lanex Regular Screens are designed for general and serial radiographic procedures. They are available from Carestream Health Inc. (Rochester, N.Y.).

For blue-sensitized coatings, a variety of blue-emitting X-ray intensifying screens such as DuPont High Plus and Kodak-branded X-OMATIC calcium tungstate screens may be used.

Optical Density (OD) including Dₘᵢₙ of each sample was measured using an X-Rite® Model 318 Densitometer (X-Rite Inc. Grandville, Mich.) equipped with a visible filter having a transmittance peak at about 530 nm.

Protec Ecomax X-Ray Film Processors are available from Protec GmBH (Oberstenfeld, Germany).

Spectral sensitization to the “blue” region (as defined above) can be provided using single dyes or blends of multiple dyes, such as a blend of spectral sensitizing dyes (SS-1) and (SS-2) identified below. The “blue” spectral sensitizing dye molar blend ratio of SS-1 to SS-2 can vary from 20:80 to 80:20, but is preferably between 30:70 and 50:50, more preferably between 35:65 and 45:55. Typically the amount of spectral sensitizing dyes is from about 200 to 1400 mg per mole of silver, preferably from about 500 to 1100 mg per mole of silver.

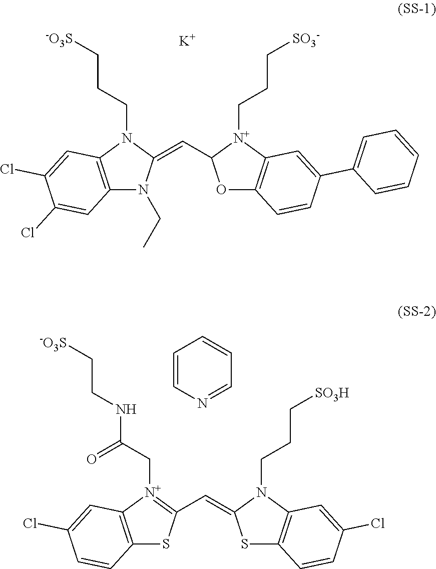

Spectral sensitization to the “green” region (as defined above) is provided using sensitive spectral sensitizing dye (SS-3) that has the structure shown below, and is preferably used at levels ranging from about 300 to 1600 mg per mole of silver.

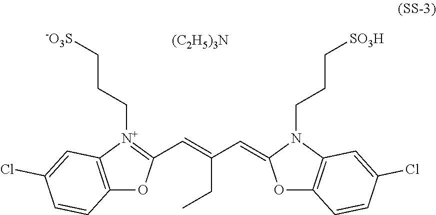

The red absorbing dye (RD-1) has the structure shown below.

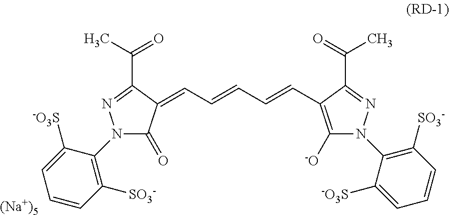

HMMP is 4′-Hydroxymethyl-4-methyl-1-phenyl-3-pyrazolidone. It has the structure shown below.

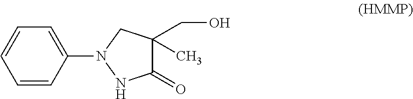

### Preparation of Silver Halide Tabular Grain Emulsions

All tabular emulsions were prepared by nucleation and growth techniques where Ag⁺ ion and Br⁻ ion solutions are added simultaneously to a temperature-controlled, stirred vessel containing an aqueous solution of bone gelatin and Br⁻ ion, and having a controlled Br⁻ ion concentration with pBr greater than 1, using techniques, devices, processes, and materials that are well established in the art. Iodide is incorporated into the silver halide grains of Emulsion 3 during growth to yield the desired halide composition.

Tabular grain emulsions that have the desired composition and sizes are described in greater detail in the following patents, the disclosures of which are incorporated herein by reference:

U.S. Pat. No. 4,414,310 (Dickerson), U.S. Pat. No. 4,425,425 (Abbott et al.), U.S. Pat. No. 4,425,426 (Abbott et al.), U.S. Pat. No. 4,439,520 (Kofron et al.), U.S. Pat. No. 4,434,226 (Wilgus et al.), U.S. Pat. No. 4,435,501 (Maskasky), U.S. Pat. No. 4,713,320 (Maskasky), U.S. Pat. No. 4,803,150 (Dickerson et al.), U.S. Pat. No. 4,900,355 (Dickerson et al.), U.S. Pat. No. 4,994,355 (Dickerson et al.), U.S. Pat. No. 4,997,750 (Dickerson et al.), U.S. Pat. No. 5,021,327 (Bunch et al.), U.S. Pat. No. 5,147,771 (Tsaur et al.), U.S. Pat. No. 5,147,772 (Tsaur et al.), U.S. Pat. No. 5,147,773 (Tsaur et al), U.S. Pat. No. 5,171,659 (Tsaur et al.), U.S. Pat. No. 5,252,442 (Dickerson et al.), U.S. Pat. No. 5,370,977 (Zietlow), U.S. Pat. No. 5,391,469 (Dickerson), U.S. Pat. No. 5,399,470 (Dickerson et al.), U.S. Pat. No. 5,411,853 (Maskasky), U.S. Pat. No. 5,418,125 (Maskasky), U.S. Pat. No. 5,494,789 (Daubendiek et al.), U.S. Pat. No. 5,503,970 (Olm et al.), U.S. Pat. No. 5,536,632 (Wen et al.), U.S. Pat. No. 5,518,872 (King et al.), U.S. Pat. No. 5,567,580 (Fenton et al.), U.S. Pat. No. 5,573,902 (Daubendiek et al.), U.S. Pat. No. 5,576,156 (Dickerson), U.S. Pat. No. 5,576,168 (Daubendiek et al.), U.S. Pat. No. 5,576,171 (Olm et al.), and U.S. Pat. No. 5,582,965 (Deaton et al.). The patents to Abbott et al., Fenton et al., Dickerson, and Dickerson et al. are also cited and incorporated herein to show conventional radiographic film features in addition to gelatino-vehicle, high bromide (greater than or equal to 80 mol % bromide based on total silver) tabular grain emulsions and other features useful in the present invention.

For Emulsion 1, a green-sensitive tabular emulsion, the nucleation and growth of the tabular grains was carried out using an additional technique developed for high-aspect-ratio grains by Daubendiek et al. (see above references, and also U.S. Pat. Nos. 4,414,310, 4,914,014, 5,503,970, 5,5039,71, 5,536,632, 5,582,965, 5,614,358, 5,641,618, 5,691,127, 6,673,529), where the nucleation is at a pBr greater than 2, the bone gelatin is oxidized and deionized, and a subsequent digestion step, prior to growth, is carried out in the presence of SCN⁻ ion, and growth is accomplished under halide-ion control where the pBr is less than or equal to 1.5. The resulting grains were, on average, 2.7 μm in diameter and 0.07 μm in thickness. Emulsion 1 is a pure AgBr emulsion. During the sensitization process for emulsion 1, green spectral sensitizing dye SS-3 was added at a level of 1365 mg of dye per mole of silver.

Emulsion 2, a green-sensitive tabular emulsion, was prepared in a similar manner using regular bone gelatin without a digestion step. The resulting grains, are, generally on average, 1.0 μm in diameter and 0.10 μm in thickness. Emulsion 2 is a pure AgBr emulsion. For emulsion 2, the green spectral sensitizing dye was added at a level of about 463 mg per mole of silver.

Emulsion 3, a blue-sensitive tabular emulsion, can be prepared by a nucleation and growth technique where Ag⁺ ion and Br⁻ ion solutions are added simultaneously to a temperature-controlled, stirred vessel containing an aqueous solution of bone gelatin and Br⁻ ion, and having a controlled Br⁻ ion concentration with pBr greater than 1, using techniques, devices, processes, and materials that are well established in the art. Iodide is incorporated into the silver halide grains of Emulsion 3 during growth to yield the desired halide composition.

For the AgBrI tabular grain blue-sensitive Emulsion 3, nucleation and growth of the tabular grains was carried out using an additional technique developed for high-aspect-ratio grains by Daubendiek et al. (see above references, and also U.S. Pat. Nos. 4,414,310, 4,914,014, 5,503,970, 5,5039,71, 5,536,632, 5,582,965, 5,614,358, 5,641,618, 5,691,127, 6,673,529), where the nucleation is at a pBr greater than 2, the bone gelatin is oxidized and deionized, a subsequent digestion step, prior to growth, is carried out in the presence of SCN⁻ ion, and growth is accomplished under halide-ion control conditions where the pBr is less than or equal to 1.5. Iodide was added in the preparation of Emulsion 3 subsequent to the nucleation step as a pBr-controlling halide salt solution containing 2.2 mol % iodide and starting after the beginning of growth (at 0.1% of the final grain volume) and ending at 62% of the final grain volume. This is intended to provide iodide in a localized portion of the grains of 0.1 to 62% where 100% refers to the grain surface. Between 62% and 100% of the grain volume the Emulsion 3 growth is carried out with a Br⁻ ion salt, yielding a silver bromide outer shell. A small amount of chloride was also added to the halide growth salts used to prepare Emulsion 3. The use of the chloride ion in tabular emulsion grain precipitations is disclosed by Delton (U.S. Pat. Nos. 5,310,644, 5,372,927, and 5,460,934). The above preparation yielded an Emulsion 3 composition of 98.5 mole % bromide and 1.5% iodide. The resulting Emulsion 3 grains are, on average, 4.3 μm in diameter and 0.07 μm in thickness. During subsequent sensitization, the blue spectral sensitizing dye SS-1 was added to Emulsion 3 at a level of 329 mg per mole of silver, and the blue spectral sensitizing dye SS-2 was added to Emulsion 3 at a level of 500 mg per mole of silver.

Green-sensitive Emulsion 1 was used in Examples 2, 3, and 6. Green-sensitive Emulsion 2 was used in Examples 1, 2, 4, and 5. Blue-sensitive Emulsion 3 was used in Example 7.

### Example 1

### Effect of Amounts of Developer and Co-Developer on Sensitometric Properties

This Example demonstrates that the use of small amounts of a co-developer (such as HMMP) can permit the use of lower amounts of developer (such as hydroquinone).

Radiographic silver halide materials were prepared and coated to achieve the layer arrangement and coating weights shown below.

Overcoat Layer
Emulsion Layer
Reflective Support (Kodak PIE paper)

| | Coverage |
|---|---|
| | (mg/dm²) |
| Overcoat Layer Formulation | |
| Gelatin vehicle | 16.0 |
| TRITON ® X-200E surfactant | 0.28 |
| Oxiranemethanol, polymer with nonylphenol | 0.86 |
| 1H,1,2,4-triazolium,1,4-diphenyl-3-(phenylamino)-, inner salt | 0.04 |
| 5-methyl-1,2,4-triazolo(1,5-a)pyrimidin-7-ol, sodium salt | 0.40 |
| Emulsion Layer Formulation | |
| AgBr tabular grain Emulsion 2, expressed as elemental silver | 10.9 |
| Gelatin vehicle | 32.8 |
| 5-Bromo-4-hydroxy-6-methyl-1,3,3a,7-tetraazaindene | 0.03 |
| Hydroquinone developer(HQ) | 11.70 |
| 4′-hydroxymethyl-4-methyl-1-phenyl | 0.15 |
| pyrazolidone (co-developer) (HMMP) | |
| Green Spectral Sensitizing Dye (SS-3) | 0.046 |
| GWN copolymer [2-Propenoic acid, butyl ester, polymer | 10.0 |
| derived from ethenylbenzene, 2-methyl-2-((1-oxo-2- | |
| propenyl)-amino)-1-propane-sulfonic acid, | |
| monosodium salt, and 2-methyl-2-propenamide] | |
| Bisvinylsulfonylmethane | 3.5% |
| (based on total gelatin on imaging side) | |

Control radiographic Film 1-A contained 11.70 mg/dm² of hydroquinone and 0.15 mg/dm² of HMMP.

Control radiographic Film 1-B was prepared as Film A, except that the coating weight of hydroquinone was reduced to 9.36 mg/dm². Control radiographic Film B also contained 0.15 mg/dm² of HMMP.

Control radiographic Film 1-C was prepared as Film A, except that the coating weight of hydroquinone was reduced to 7.02 mg/dm². Control radiographic Film C also contained 0.15 mg/dm² of HMMP.

Control radiographic Film 1-D was prepared as Film A, except that the coating weight of hydroquinone level was reduced to 4.68 mg/dm². Control radiographic Film D also contained 0.15 mg/dm² of HMMP.

Inventive radiographic Film 1-E was prepared as Film A, except that the coating weight of hydroquinone was reduced to 4.68 mg/dm². Control radiographic Film E also contained 0.30 mg/dm² of HMMP.

Samples of radiographic films 1-A to 1-E were developed using a Carestream 5000RA deep-tank film processor using the comparative developer solution shown above in TABLE II. This comparative developer solution is referred to as a “full strength developer” solution.

Control Film 1-A had a high level of hydroquinone. This film was difficult to coat, and dry. Control Films 1-B through 1-D had a reduced level of hydroquinone resulting in lower photographic speed. Inventive Film 1-E had a low level of hydroquinone but because of its higher level of HMMP, film speed was maintained.

Emulsion Layer and Overcoat Layer formulations were coated under safelight conditions onto Kodak Professional Endura Paper. This paper has a matte finish. The formulations were coated using an automatic coating machine using a slide hopper. The hydrophilic colloid layers were coated simultaneously. The coating speed was about 40 feet per minute. The emulsion layer was coated to achieve a dry coating weight of 33.8 mg/dm². The overcoat layer was coated to achieve a dry coating weight of 16.35 mg/dm². The coated film was dried at 25° C. for 2 min.

Samples of the green-sensitive reflective radiographic Film 1-A were exposed, through a graduated density step tablet, to a 500 watt General Electric DMX projector lamp in a Macbeth sensitometer for 1/50^{th} second, calibrated to 2650° K, filtered with a Corning C4010 filter to simulate a green-light emitting phosphor from a green-emitting fluorescent intensifying screen.

Samples of blue-sensitive reflective radiographic films can be similarly exposed using a Corning filter to simulate a blue-emitting phosphor in a blue-light emitting fluorescent intensifying screen.

After exposure, the samples of reflective radiographic films were developed using a Protec Ecomax X-ray film processor using the “full strength” developer solution (TABLE II) for about 25 seconds at 30-34° C. followed by fixing using the fixing solution (TABLE III) for about 25 seconds at 20-30° C. The samples were then washed with water for about 25 seconds at 5-30° C.

The sensitometric response of these radiographic films, shown below in TABLE IV indicates that the addition of a co-developer at low developer concentrations has little effect when used with a full strength developer. When one uses a dilute developer (TABLE V), one sees the benefit of the increased level of co-developer.

TABLE IV
Development Using Full Strength Developer Solution

| | | Coating Weight | | | | |
|---|---|---|---|---|---|---|
| | | mg/dm² | | | | |
| Sample | | HQ | HMMP | Speed 1.0 | Dₘᵢₙ | UDP |
| Film 1-A | Control | 11.70 | 0.15 | 471 | 0.112 | 1.89 |
| Film 1-B | Control | 9.36 | 0.15 | 470 | 0.103 | 1.9 |
| Film 1-C | Control | 7.02 | 0.15 | 469 | 0.103 | 1.87 |
| Film 1-D | Control | 4.68 | 0.15 | 467 | 0.107 | 1.81 |
| Film 1-E | Invention | 4.68 | 0.30 | 467 | 0.101 | 1.81 |

Samples of radiographic Films 1 to 1-E were also developed using a Protec Ecomax X-ray shallow-tank film processor using the inventive developer solution shown above in TABLE II. This developer solution is referred to as a “dilute developer solution.”

The sensitometric response of these radiographic films, shown below in TABLE V, indicates that as hydroquinone is reduced, film speed is reduced. However, an increase in the amount of HMMP increases film speed. As noted above, high levels of hydroquinone in a radiographic coatings reduces the gelatin structure, results in a high film tackiness, and interferes with the ability of the coating melt to chill set, thus requiring lower coating speeds in manufacturing.

TABLE V
Development Using Dilute Developer Solution

| | | Coating Weight | | | | |
|---|---|---|---|---|---|---|
| | | mg/dm² | | | | |
| Sample | | HQ | HMMP | Speed 1.0 | Dₘᵢₙ | UDP |
| Film 1-A | Control | 11.70 | 0.15 | 450 | 0.07 | 1.66 |
| Film 1-B | Control | 9.36 | 0.15 | 449 | 0.09 | 1.63 |
| Film 1-C | Control | 7.02 | 0.15 | 437 | 0.08 | 1.63 |
| Film 1-D | Control | 4.68 | 0.15 | 429 | 0.06 | 1.65 |
| Film 1-E | Invention | 4.68 | 0.30 | 449 | 0.07 | 1.62 |

### Example 2

### Improved Exposure Latitude of Reflective Papers

Example 2 compares several commercially available films for X-ray applications as well as differing paper coatings with increased exposure latitude achieved either by emulsion blending or by emulsion choice.

Radiographic Film 2-A is commercially available Carestream MXG (TMG) radiographic film that is considered to be a high contrast, low exposure latitude radiographic film. This film is coated onto a transparent blue support.

Film 2-B is commercially available Carestream TMAT-S (TMS) radiographic film that is considered to be a medium contrast radiographic film. This film is coated onto a transparent blue support.

Film 2-C is commercially available Carestream TMAT-L (TML) radiographic film. It is considered to be a low contrast radiographic film with wide exposure latitude. This film is coated onto a transparent blue support.

Paper 2-A is coated like Film 1-A as described above except it is coated onto reflective paper using 16.3 mg Ag/dm² of Emulsion 1.

Emulsion 1 is an AgBr tabular grain emulsion with a diameter of 2.7 μm average×0.07 μm thickness,

Paper 2-B is coated like Film 1-A except it is coated onto reflective paper with a blend of Emulsion 1 and Emulsion 2 at the ratios indicated in TABLE VI below.

Emulsion 2 is an AgBr tabular grain emulsion with a diameter of 1.0 μm average×0.11 μm thickness.

Paper 2-C is like Film 1-A except it is coated onto reflective paper with a blend of Emulsion 1 and Emulsion 2 at the ratios indicated in TABLE VI below.

Paper 2-D is like Film 1-A except it is coated onto reflective paper with a blend of Emulsion 1 and Emulsion 2 at the ratios indicated in TABLE VI below.

Paper 2-E is like Film 1-A except it is coated onto reflective paper using Emulsion 2 alone at the levels indicated in the table below.

Samples of the reflective radiographic materials were exposed using a GE Proteus XR model # ML02F medical X-ray unit. For these exposures, the film was arranged in a screen/film assembly as follows:

21-step Aluminum wedge

Front screen

Film

Radiation absorbing black sheet

Back Screen

An X-radiation exposure profile was generated by placing an aluminum step wedge between the screen/film assembly and the X-ray source, where this wedge was 152 cm from the X-ray aperture. The distance from the X-ray source to the surface of the screen/film assembly was fixed. The X-ray aperture was adjusted to yield a full field of radiation impinging on the 43.2×24 cm step wedge. The X-ray voltage was 70 kV, with a 100 ms×50 mA exposure used with green films and 125 ms×100 mA exposure for blue films. Commercially available screen cassettes enable this film arrangement. For green films, the screen cassette was Lanex Regular, and for blue films DuPont High Plus screen cassettes were used.

Samples were developed using a Carestream 5000RA film processor for about 24 seconds at 35° C. followed by fixing using the fixing solution (TABLE III) for about 24 seconds at 35° C. The samples were then washed with water at 29° C. for about 24 seconds

TABLE VI shows the sensitometric results obtained from an X-ray exposure at 70 Kv and using a Lanex Regular cassette.

TABLE VI shows that the peak gamma of the films are considerably higher than those of the papers. This is because the density range of the films is much greater (Dₘₐₓ−Dₘᵢₙ is 3.0 or greater). For papers, the density range is 1.7.

Peak gamma is the maximum gamma in the plot of gamma vs. log E. Contrast Latitude (CL) is the width (in terms of log E) of the gamma plot at 50% of the peak gamma, where the gamma value is at least 50% of the peak gamma over the entire CL range. The CL values for the inventive examples in Table VI are all greater than 0.7.

Because of the limited density range of the radiographic papers, gamma and exposure latitude need to be carefully allocated. For imaging of extremities such as bones (which have a narrow X-ray attenuation), it may be desirable to have high contrast or gamma. For imaging of the chest (which requires wide latitude because there is a wide range of anatomy with differing X-ray attenuation (i.e., lungs, retrodiaphragm, heart and the vertebral column) wider exposure latitude is need.

Control Paper 2-A has the highest peak gamma of the papers tested but the exposure latitude is even narrower than that of the narrowest film example. Thus, this paper would not be good for chest exams. Papers 2-C to 2-E, although they have lower peak gamma, have wider exposure latitude than either of the two high contrast films, and approach that of the wide latitude film (TMat-L). These papers represent a good compromise for both extremity and chest imaging.

TABLE VI

| | | | | | 70 kv Wedge Sensitometry | | |
|---|---|---|---|---|---|---|---|
| Full Strength Developer | | | Emulsion | | Speed | Peak | Contrast |
| Sample | Film | Paper | Emulsion 2 | Emulsion 1 | 1.0 | Gamma | Latitude |
| Film 2-A | TMG | — | — | — | 161 | 3.8 | 0.77 |
| Film 2-B | TMS | — | — | — | 162 | 3.5 | 0.74 |
| Film 2-C | TML | — | — | — | 156 | 2.8 | 0.97 |
| Paper 2-A | Control | PIE | 0 | 16.3 | 189 | 2.6 | 0.6 |
| Paper 2-B | Control | PIE | 5.45 | 10.9 | 188 | 2.5 | 0.7 |
| Paper 2-C | Invention | PIE | 8.2 | 8.2 | 184 | 2.2 | 0.75 |
| Paper 2-D | Invention | PIE | 10.9 | 5.45 | 179 | 2.2 | 0.81 |
| Paper 2-E | Invention | PIE | 16.3 | 0 | 169 | 2.2 | 0.78 |

### Example 3

### Red Absorbing Dyes for Improved Safelight Protection

Chemical sensitization of the silver halide emulsion forms silver sulfide. Most methods of chemical sensitization of the silver halide emulsion use sulfur compounds such as sodium or potassium thiosulfate as well as gold compounds. A side effect of chemical sensitization is the formation of silver sulfide (Ag₂S), which unfortunately imparts sensitization to the silver halide grains to red light at 600-650 nm. Upon imaging and development, image fog is produced. This is evidenced by an increase in Dₘᵢₙ. The addition of a red absorbing dye was found to reduce the sensitivity of the radiographic film to red light.

Control Film 3-A is like Film 1-A described above but contained 9.25 mg/dm² of Emulsion 1.

Reflective paper 3-B is like Film 1-A except that 0.33 mg/dm² of red absorbing dye (RD-1) was added to the emulsion layer.

Reflective paper 3-C is like Film 1-A except that 0.49 mg/dm² of red absorbing dye (RD-1) was added to the emulsion layer.

Reflective paper 3-D is like Film 1-A except that 0.66 mg/dm² of red absorbing dye (RD-1) was added to the emulsion layer.

Safelight testing was done using two different measures of safelight sensitivity. One is latensification and the other is hypersensitization. Latensification is determined by giving the film a sensitometric exposure followed by a 2 minute exposure to red safelights. The difference in density between the film exposed to the red safelight and the density without the exposure to the red safelight is measured. Hypersensitization is determined by giving the film a 2-minute exposure to red safelights followed by a sensitometric exposure. The difference in density between the film exposed to the red safelight and the density without the exposure to the red safelight is measured. Samples were tested using a safelight equipped with a dark-red Kodak GBX-2 safelight filter. Samples were also tested using a Kodak LED Safelight. This safelight is comprised of a cluster of 20 red light-emitting diodes (LED's) arrayed on a traditional light bulb housing. The LED safelight is designed to replace conventional filtered incandescent safelights.

Samples were developed using a Carestream 5000RA film processor for about 24 seconds at 35° C. followed by fixing using the fixing solution (TABLE III) for about 24 seconds at 35° C. The samples were then washed with water at 29° C. for about 24 seconds

The results of safelight testing, shown below in TABLE VII, indicates that addition of a red absorbing dye reduces the amount of safelight-induced fog.

TABLE VII

| | | | | | | Safelight Testing | | | |
|---|---|---|---|---|---|---|---|---|---|
| | | Red Absorbing | | | | | | Hyper | |
| | Emulsion 1 | Dye (RD-1) | | Speed | | Latensification | | Sensitization | |
| Sample | mg/dm² | mg/dm² | Dₘᵢₙ | 1.0 | UDP | GBX-2 | LED | GBX-2 | LED |
| Control 3-A | 9.25 | 0 | 0.06 | 474 | 1.81 | 0.29 | 0.31 | 0.15 | 0.14 |
| Invention 3-B | 9.25 | 0.33 | 0.06 | 463 | 1.81 | 0.07 | 0.09 | 0.04 | 0.04 |
| Invention 3-C | 9.25 | 0.49 | 0.06 | 459 | 1.81 | 0.06 | 0.05 | 0.03 | 0.05 |
| Invention 3-D | 9.25 | 0.66 | 0.09 | 455 | 1.8 | 0.04 | 0.04 | 0.03 | 0.01 |

### Example 4

### Paper with Structured Surface for Improved Transport and Lower Gloss

Inventive Sample 4-A was prepared in the same manner as Material 1-A above except that it used silver halide Emulsion 2. Emulsion 2 is an AgBr tabular grain emulsion with grains having a diameter of 1.0 μm average×0.11 μm thickness. Inventive Sample 4-A was coated on Kodak Professional Endura paper. This paper has an embossed structure.

Control paper 4-B was prepared in a similar manner to sample 4-A paper used in sample 4-A except it was coated on Kodak Consumer F paper.

Inventive paper 4-C was prepared in a similar manner to that of control paper 4-B except that the overcoat layer contained 10 mg/dm² of 4 μm poly(methylmethacrylate) beads. It was coated on Kodak Consumer F paper.

Inventive paper 4-D was prepared in a similar manner to sample 4-B except that it contained 15 mg/dm² of 4 μm poly(methylmethacrylate) beads. It was coated on Kodak Consumer F paper.

Inventive paper 4-E was prepared in a similar manner to sample 4-B except that it contained 20 mg/dm² 4 μm poly(methylmethacrylate) beads.

Samples of the reflective radiographic films were exposed, through a graduated density step tablet, to a 500 watt General Electric DMX projector lamp in a Macbeth sensitometer for 1/50^{th} second, calibrated to 2650° K, filtered with a Corning C4010 filter to simulate a green-light emitting phosphor from a green-emitting fluorescent intensifying screen.

Samples were developed using a Carestream 5000RA film processor for about 24 seconds at 35° C. followed by fixing using the fixing solution (TABLE III) for about 24 seconds at 35° C. The samples were then washed with water at 29° C. for about 24 seconds

The results, shown below in TABLE VIII, demonstrate that radiographic films incorporating low levels of developer when coated onto papers having a matte surface have low gloss and are easily transported through film processors such as the Protec Model Protec Ecomax X-Ray Film Processors. Control paper 4-B that was coated on a high gloss photographic paper does not transport well through a film processor. Inventive papers C-E that contained various levels of 4 μm poly(methylmethacrylate) matte beads had low gloss and were easily transported through the Protec Film Processor.

TABLE VIII

| | | PMMA Beads | Transport | Gloss 20 |
|---|---|---|---|---|
| Sample | Paper | mg/dm² | Protec | Average |
| Invention 4-A | PIE | 0 | Yes | 5.6 |
| Control 4-B | CIF | 0 | No | 71.4 |
| Invention 4-C | CIF | 10.0 | Yes | 46.6 |
| Invention 4-D | CIF | 15.0 | Yes | 38.5 |
| Invention 4-E | CIF | 20.0 | Yes | 32.5 |

### Example 5

### Development of Reflective Film with Incorporated Developer Using Dilute Developer Chemistries

The following example demonstrates radiographic silver halide emulsions coated onto reflective paper supports containing a portion of the developer chemistry incorporated within the radiographic film. The remainder of the developer chemistry is contained in a dilute developer solution. These films provide radiographic images with good speed and UDP (upper density point).

Reflective Film 5-A is like Film 1-A except it contains 5.50 mg/dm² hydroquinone and 0.3 mg/dm² HMMP within the emulsion formulation.

Reflective Film 5-B is like Film 1-A except it contains 11 mg/dm² hydroquinone and 0.15 mg/dm² HMMP within the emulsion formulation.

Reflective Film 5-C is like Film 1-A except it contains 0 mg/dm² hydroquinone and HMMP within the emulsion formulation.

The composition of the developer solutions are shown in TABLE III above, with the following changes.

Control Developer Solution 5-A represents a full strength developer.

Control Developer Solution 5-B has 4.75 g/l hydroquinone, 0.5 g/l HMMP, and 0.025 g/l of phenylmercaptotetrazole (PMT).

Control Developer Solution 5-C represents a dilute developer and has 2.38 g/l of hydroquinone, 0.25 g/l of HMMP, and no (i.e., 0.0 g/l) of phenyl-mercaptotetrazole.

Inventive Developer Solution 5-D represents a dilute developer and has 2.38 g/l of hydroquinone, 0.25 g/l of HMMP, and 0.025 g/l of phenyl-mercaptotetrazole.

Inventive Developer Solution 5-E represents a dilute developer and has 2.38 g/l of hydroquinone, 0.25 g/l HMMP, and 0.05 g/l phenylmercapto-tetrazole.

Control Developer Solution 5-F represents a dilute developer and has 2.38 g/l of hydroquinone, 0.25 g/l of HMMP, and 0.1 g/l of phenylmercapto-tetrazole.

Control Developer Solution 5-G has no (i.e., 0.0 g/l) of hydroquinone, 0.25 g/l of HMMP, and no (i.e., 0.0 g/l) of phenylmercapto-tetrazole.

Control Developer Solution 5-H has no hydroquinone, no HMMP, and no phenylmercaptotetrazole.

Samples of the reflective radiographic films were exposed, through a graduated density step tablet, to a 500 watt General Electric DMX projector lamp in a Macbeth sensitometer for 1/50^{th} second, calibrated to 2650° K, filtered with a Corning C4010 filter to simulate a green-light emitting phosphor from a green-emitting fluorescent intensifying screen.

The films in TABLE IX were developed using a Carestream 5000RA film processor as described above. The films in TABLES XII through TABLE XVI were developed using a Protec Ecomax film processor as described above.

TABLES IX through XVI show the sensitometric results from the reflective papers tested with the various developers described above. These results demonstrate that the placing a portion of the developer in the radiographic film and a portion of the developer in a dilute developer solution provides radiographic films with sensitometric properties similar to those of radiographic films containing no developer within the film and developed using external developer solutions.

TABLE IX shows that nearly full development is achieved for all papers when processed in a full strength developer solution regardless of whether they contain incorporated developers or not.

TABLE X again shows similar sensitometry for all papers when processed in a dilute (25%) developer solution regardless of whether they contain incorporated developers or not.

TABLE XI shows similar sensitometry for papers 5-A and 5-B when processed in a dilute (12.5%) developer solution with no (i.e., 0.0 g) PMT. However, Paper 5-C begins to lose speed and UDP.

TABLE XII shows similar sensitometry for papers 5-A and 5-B when processed in a dilute (12.5%) developer solution with 0.025 g PMT. However, Paper 5-C shows a loss in speed and UDP. This higher PMT level significantly improves lower scale contrast (LSC), which results in an improved ability to visualize faint anatomy.

TABLE XIII shows similar sensitometry for papers 5-A and 5-B when processed in a dilute (12.5%) developer solution with 0.05 g PMT. However, Paper 5-C begins to lose speed and UDP. At this level of PMT, lower scale contrast is greatly improved.

TABLE XIV show that the highest levels of PMT slow down the rate of development and result in lower speed and UDP and lower scale contrast is no longer improved.

TABLE XV shows that none of the reflective papers has enough sensitivity to achieve a high enough UDP when processed in a dilute developer solution containing 0 g hydroquinone. Speed is unable to be determined.

TABLE XVI shows that none of the reflective papers have enough sensitivity to achieve a high enough UDP when processed in a dilute developer solution containing no (i.e., 0.0 g) hydroquinone and no (i.e., 0.0 g) HMMP. Speed is unable to be determined.

TABLE IX

| Developer 5-A | HQ | HMMP | PMT | Speed 1.0 | UDP |
|---|---|---|---|---|---|
| Film 5-A | 19 | 2 | 0.025 | 437 | 1.830 |
| Film 5-B | 19 | 2 | 0.025 | 437 | 1.930 |
| Film 5-C | 19 | 2 | 0.025 | 430 | 1.670 |

TABLE X

| Developer 5-B | HQ | HMMP | PMT | Speed 1.0 | UDP |
|---|---|---|---|---|---|
| Film 5-A | 4.75 | 0.5 | 0.025 | 421 | 1.79 |
| Film 5-B | 4.75 | 0.5 | 0.025 | 422 | 1.83 |
| Film 5-C | 4.75 | 0.5 | 0.025 | 414 | 1.70 |

TABLE XI

| Developer 5-C | HQ | HMMP | PMT | Speed 1.0 | UDP | LSC |
|---|---|---|---|---|---|---|
| Film 5-A | 2.38 | 0.25 | 0 | 414 | 1.7 | 1.03 |
| Film 5-B | 2.38 | 0.25 | 0 | 413 | 1.7 | 1.05 |
| Film 5-C | 2.38 | 0.25 | 0 | 396 | 1.3 | 1.1 |

TABLE XII

| Developer 5-D | HQ | HMMP | PMT | Speed 1.0 | UDP | LSC |
|---|---|---|---|---|---|---|
| Film 5-A | 2.38 | 0.25 | 0.025 | 413 | 1.74 | 1.32 |
| Film 5-B | 2.38 | 0.25 | 0.025 | 414 | 1.78 | 1.32 |
| Film 5-C | 2.38 | 0.25 | 0.025 | 398 | 1.43 | 1.29 |

TABLE XIII

| Developer 5-E | HQ | HMMP | PMT | Speed 1.0 | UDP | LSC |
|---|---|---|---|---|---|---|
| Film 5-A | 2.38 | 0.25 | 0.05 | 412 | 1.73 | 1.43 |
| Film 5-B | 2.38 | 0.25 | 0.05 | 413 | 1.76 | 1.46 |
| Film 5-C | 2.38 | 0.25 | 0.05 | 378 | 1.42 | 1.3 |

TABLE XIV

| Developer 5-F | HQ | HMMP | PMT | Speed 1.0 | UDP | LSC |
|---|---|---|---|---|---|---|
| Film 5-A | 2.38 | 0.25 | 0.1 | 392 | 1.48 | 1.43 |
| Film 5-B | 2.38 | 0.25 | 0.1 | 377 | 1.49 | 1.28 |
| Film 5-C | 2.38 | 0.25 | 0.1 | 367 | 0.97 | 0.87 |

TABLE XV

| Developer 5-G | HQ | HMMP | PMT | Speed 1.0 | UDP |
|---|---|---|---|---|---|
| Film 5-A | 0 | 0.25 | 0 | — | 0.96 |
| Film 5-B | 0 | 0.25 | 0 | — | 1.27 |
| Film 5-C | 0 | 0.25 | 0 | — | 0.1 |

TABLE XVI

| Developer 5-H | HQ | HMMP | PMT | Speed 1.0 | UDP |
|---|---|---|---|---|---|
| Film 5-A | 0 | 0 | 0 | — | 0.42 |
| Film 5-B | 0 | 0 | 0 | — | 0.1 |
| Film 5-C | 0 | 0 | 0 | — | 0 |

### Example 6

### Comparison of Films Incorporating Developer with Films not Incorporating Developer

This example demonstrates that incorporation of a portion of the developer chemistry within the radiographic film and having the remainder of the developer chemistry in the developer solution provides a method of replenishing the developer solution chemistry, and allows the developer solution to be used for a longer period of time before it becomes exhausted and needs to be replenished.

Radiographic silver halide materials were prepared and coated to achieve the layer arrangement and coating weights shown below.

Overcoat Layer
Emulsion Layer
Reflective Support (Kodak PIE paper)

| | Coverage |
|---|---|
| | (mg/dm²) |
| Overcoat Layer Formulation | |
| Gelatin vehicle | 16.0 |
| TRITON ® X-200E surfactant | 0.28 |
| Oxiranemethanol, polymer with nonylphenol | 0.86 |
| 1H,1,2,4-triazolium,1,4-diphenyl- | 0.04 |
| 3-(phenylamino)-, inner salt | |
| 5-methyl-1,2,4-triazolo(1,5-a)pyrimidin-7-ol, | 0.40 |
| sodium salt | |
| Emulsion Layer Formulation | |
| AgBr tabular grain Emulsion 1, expressed as elemental silver | 10.9 |
| Gelatin vehicle | 32.8 |
| 5-Bromo-4-hydroxy-6-methyl-1,3,3a,7-tetraazaindene | 0.03 |
| Hydroquinone developer(HQ) | 11.70 |
| 4′-hydroxymethyl-4-methyl-1-phenyl | 0.15 |
| pyrazolidone (co-developer) (HMMP) | |
| Green Spectral Sensitizing Dye (SS-3) | 0.14 |
| GWN copolymer [2-Propenoic acid, butyl ester, polymer | 10.0 |
| derived from ethenylbenzene, 2-methyl-2-((1-oxo-2- | |
| propenyl)-amino)-1-propane-sulfonic acid, | |
| monosodium salt, and 2-methyl-2-propenamide] | |
| Bisvinylsulfonylmethane | 3.5% |
| (based on total gelatin on imaging side) | |

Radiographic Film 2 was prepared in the same manner as radiographic Paper 1 except it contains no (i.e., 0.0 g) hydroquinone and no (i.e., 0.0 g) of HMMP.

Radiographic Paper 1 contained a portion of the developer and co-developer within the radiographic film and the remainder of the developer and co-developer in a dilute developer solution. Comparative Radiographic Film 2 contained no developer within the radiographic film. (TABLE XVII). The developer for both the inventive radiographic film and comparative radiographic film was a dilute developer. (TABLE XVIII).

Samples of the reflective radiographic films were exposed, through a graduated density step tablet, to a 500 watt General Electric DMX projector lamp in a Macbeth sensitometer for 1/50^{th} second, calibrated to 2650° K, filtered with a Corning C4010 filter to simulate a green-light emitting phosphor from a green-emitting fluorescent intensifying screen.

Samples were processed using a tabletop shallow-tank processor using the developer solution shown in TABLE XVIII. Before testing, fully exposed photosensitive paper containing neither developer nor co-developer was processed until the developer solution approached exhaustion. Film samples having photosensitive paper containing developer and co-developer were then processed.

As processing was carried out, some developer and co-developer in the film diffused out and replenished the developer solution chemistry. The results, shown below in TABLE XIX, also demonstrate that radiographic films incorporating a portion of the developer within the film and the remainder of the developer in a dilute solution had little loss in speed after 194 sheets were developed (ΔSpeed 1.0=1; ΔUDP=0.03). In contrast, Comparative Radiographic Film 2, containing no developer and co-developer within the radiographic film and developed using the same dilute developer and co-developer, showed a significant speed loss (ΔSpeed 1.0>72) and significant loss in UDP (ΔUDP=0.56).

TABLE XVII

| | Inventive | | Comparative |
|---|---|---|---|
| | Radiographic Paper | | Radiographic Paper |
| Material | 6-1 | | 6-2 |
| Developer (HQ) | 11.70 | mg/dm² | 0 |
| Co-Developer (HMMP) | 0.15 | mg/dm² | 0 |
| Hardener (BVSM) | 3.5 | wt % | 3.5 wt % |

TABLE XVIII

| | Developer Solution for |
|---|---|
| | Inventive Radiographic Film |
| Material | 6-1 and 6-2 |
| Developer (HQ) | 2.38 g/L |
| Co-Developer (HMMP) | 0.25 g/L |
| PMT | 0.013 g/L |
| pH | 11.8 |

The fixer solution for both radiographic films contained 75 g of (NH₄)₂S₂O₃ and 2.5 g of BVSM hardener. It had a pH of 4.9.

TABLE XIX

| Sample | Sheet Number | GF | Speed 1.0 | LSC | UDP |
|---|---|---|---|---|---|
| Inventive | 0 | 0.20 | 436 | 2.04 | 1.98 |
| Radiographic | 174 | 0.20 | 435 | 1.95 | 1.95 |
| Film 6-1 | 194 | 0.20 | 435 | 1.92 | 1.95 |
| | Change | | Δ = 1 | Δ = 0.12 | Δ = 0.03 |
| | after processing | | | | |
| | 194 sheets | | | | |
| Comparative | 0 | 0.29 | 432 | 1.93 | 1.80 |
| Radiographic | 154 | 0.31 | 388 | 1.04 | 1.51 |
| Film 6-2 | 174 | 0.31 | 360 | 0.68 | 1.47 |
| | 194 | 0.31 | NA | 0.34 | 1.26 |

| | | | |
|---|---|---|---|
| Change | Δ > 72 | Δ = 1.59 | Δ = 0.54 |
| after processing | | | |
| 194 sheets | | | |

### Example 7

Blue-sensitive x-ray films are used in combination with blue-emitting intensifying screens in many areas of the world. One common method to increase the emulsion sensitivity in the blue region of the spectrum is to use higher levels of iodide in the emulsion grain. This enhances the sensitivity of the grain by broadening the wavelength sensitivity to longer wavelengths. A consequence of higher iodide levels in decreased developability in many developer solutions. We have found that film incorporation of hydroquinone and HMMP enhances the developability of blue-sensitive x-ray films in both full strength and dilute developers.

Table XX shows the range of principle primary active ingredients (PAI) as coated in radiographic films as well as typical amounts used in a blue-sensitive coating formulation. Silver is in the form of a silver halide emulsion, HQ is hydroquinone developer, HMMP is the co-developer specified in the table, and the blue sensitizing dyes are SS-1 and SS-2 noted above that impart blue sensitivity to the emulsion.

TABLE XX

| | Invention | Invention |
|---|---|---|
| | Primary Active | Primary Active |
| Coating Level | Ingredient - Typical | Ingredient - Range |
| Description | (mg/dm²) | (mg/dm²) |
| Silver | 10.76 | 2.50 to 50.0 |
| Gelatin | 47.8 | 3.0 to 60.0 |
| Hardener | 3.5% of gel | 0.25 to 5.0% |
| HQ (developer) | 5.85 | 1.0 to 20.0 |
| HMMP (co-developer) | 0.30 | 0.05 to 1.00 |
| Sensitizing Dyes (SS-1 | 0.082 | 0.05 to 0.25 |
| combined with SS-2) | | |
| Ratio HQ/HMMP | 20:1 (wt. ratio) | 5:1-50:1 |

The following Example also demonstrates that the use of small amounts of a co-developer (such as HMMP) permits the use of lower amounts of developer (such as hydroquinone).

Radiographic silver halide materials were prepared and coated to achieve the layer arrangement and coating weights shown below.

Overcoat Layer
Emulsion Layer
Reflective Support

| | Coverage |
|---|---|
| | (mg/dm²) |
| Overcoat Layer Formulation | |
| Gelatin vehicle | 15.0 |
| TRITON ® X-200E surfactant | 0.33 |
| Oxiranemethanol, polymer with nonylphenol | 0.86 |
| 1H,1,2,4-triazolium,1,4-diphenyl- | 0.04 |
| 3-(phenylamino)-, inner salt | |
| 5-methyl-1,2,4-triazolo(1,5-a)pyrimidin-7-ol, | 0.40 |
| sodium salt | |
| Emulsion Layer Formulation | |
| AgBr tabular grain Emulsion 3, | 10.76 |
| expressed as elemental silver | |
| Gelatin vehicle | 32.8 |
| 5-Bromo-4-hydroxy-6-methyl-1,3,3a,7-tetraazaindene | 0.028 |
| Hydroquinone developer(HQ) | 0 to 5.85 |
| 4′-hydroxymethyl-4-methyl-1-phenyl | 0 to 0.30 |
| pyrazolidone (co-developer) (HMMP) | |
| Blue Spectral Sensitizing Dyes (SS-1 and SS-2) | 0.082 |
| GWN copolymer [2-Propenoic acid, butyl ester, polymer | 10.0 |
| derived from ethenylbenzene, 2-methyl-2-((1-oxo-2- | |
| propenyl)-amino)-1-propane-sulfonic acid, monosodium salt, | |
| and 2-methyl-2-propenamide] | |
| Bisvinylsulfonylmethane | 3.5% |
| (based on total gelatin on imaging side) | |

Control radiographic Film Blue 7-A contained 0 mg/dm² of hydroquinone and 0 mg/dm² of HMMP.

Control radiographic Film Blue 7-B was prepared as Film Blue A, except that hydroquinone and HMMP were added. The level of hydroquinone was 2.9 mg/dm², and the level of HMMP was 0.15 mg/dm².

Control radiographic Film Blue 7-C was prepared as Film A, except that the coating weight of hydroquinone was increased to 5.85 mg/dm². Inventive radiographic Film C also contained 0.30 mg/dm² of HMMP.

Samples of radiographic films Blue 7-A to 7-C were developed using a Carestream 5000RA deep-tank film processor using the comparative developer solution shown above in TABLE II. This comparative developer solution is referred to as a “full strength developer” solution.

Control Film 7-A had a no hydroquinone and no HMMP (zero level). Inventive films 7-B and 7-C had a 50% level of hydroquinone and HMMP and a 100% level, respectively.

Samples of the reflective radiographic films were inserted into a screen/film assembly using a DuPont High Plus cassette and exposed using the same X-ray technique as described in Example 2.

After exposure, the samples of reflective radiographic films were developed using a Protec Ecomax X-ray film processor using the “full strength” developer solution (TABLE II above) for about 25 seconds at 30-34° C. followed by fixing using the fixing solution (TABLE III above) for about 25 seconds at 20-30° C. The samples were then washed with water for about 25 seconds at 5-30° C.

The sensitometric response of these radiographic films, shown below in TABLE XXI indicates that the addition of a incorporated developer co-developer improves MSC and UDP while significantly reduces Dₘᵢₙ when used with a full strength developer.

The sensitometric data, shown below in TABLES XXI and XXII, demonstrate that inventive films 7-B and 7-C that incorporate developer have higher contrast and UDP than control Film 7-A that does not incorporate a developer. Additionally, the Dₘᵢₙ of the inventive films is significantly lower than that of the control film.

The data in these two tables also demonstrate that blue-sensitive x-ray films having higher iodide levels than similarly prepared green-sensitive films have improved developability in both full strength and dilute developer solutions.

Samples of radiographic Films 7-A to 7-C were also developed using a Protec Ecomax X-ray shallow-tank film processor using the inventive developer solution shown above in TABLE II. This developer solution is referred to as a “dilute developer solution.”

TABLE XXI
Development Using Full Strength Developer Solution

| | | Coating Weight | | | | | | | |
|---|---|---|---|---|---|---|---|---|---|
| | | mg/dm² | | Speed | Peak | | | | |
| Sample | | HQ | HMMP | 1.0 | Gamma | CL | Dₘᵢₙ | MSC | UDP |
| Film 7-A | Control | 0 | 0 | 175 | 1.8 | 0.83 | 0.22 | 1.12 | 1.78 |
| Film 7-B | Invention | 2.9 | 0.15 | 173 | 1.9 | 0.83 | 0..09 | 1.59 | 1.80 |
| Film 7-C | Invention | 5.85 | 0.30 | 174 | 1.9 | 0.84 | 0.09 | 1.63 | 1.84 |

TABLE XXII
Development Using Dilute Developer Solution

| | | Coating Weight | | | | | | | |
|---|---|---|---|---|---|---|---|---|---|
| | | mg/dm² | | Speed | Peak | | | | |
| Sample | | HQ | HMMP | 1.0 | Gamma | CL | Dₘᵢₙ | MSC | UDP |
| Film 10-A | Control | 0 | 0 | 154 | 1.5 | 0.93 | 0.21 | 0.9 | 1.74 |
| Film 10-B | Invention | 2.9 | 0.15 | 153 | 1.7 | 0.97 | 0.09 | 1.5 | 1.81 |
| Film 10-C | Invention | 5.85 | 0.3 | 155 | 1.8 | 0.99 | 0.09 | 1.58 | 1.89 |

### Opacifying Layers for Single Sided Radiographic Films

A radiographic film having an emulsion coated on only one side of a support is referred to as a “single sided” radiographic film. Such films require a support that is substantially opaque to transmitted light so that the developed radiographic image can be viewed using reflected light and without the need for a light box. However, when such a radiographic film is imaged using a dual-screen cassette, screen light emitted from the backside screen is transmitted through the support and images the frontside emulsion. This effect is referred to as “punch through.” Because the frontside screen also images the frontside emulsion, upon development, the combination of the two images results in an unsharp image.

Thus, in another embodiment, the invention provides a reflective radiographic silver halide film comprising a reflective support having first and second major surfaces, the reflective radiographic film having disposed on the first major reflective support surface only, one or more gelatin layers including a tabular silver halide emulsion layer and a protective gelatin overcoat layer, and an opacifying layer. The opacifying layer may be located on the frontside of the support between the emulsion layer and the support, within the support, or anywhere on the backside of the radiographic film.

To ensure that light emitted from a backside phosphor screen is effectively absorbed, it is useful that the opacifying layer have an optical density of between 0.9 and 6, at the wavelengths to which the photosensitive emulsion is spectrally sensitized. This is also the spectral region of emission of the backside phosphor. It is more useful that the opacifying layer have a maximum optical density of between 0.9 and 4 and even more useful that it have an optical density of between 0.9 and 3. The optical density of such layers eliminate “punch through.”

“Punch through” is exposure of the frontside photosensitive emulsion layers by light emitted from the backside phosphor screen. “Punch through” exposure causes an unsharp image, and lower image quality of the radiograph. Reducing punch through improves image quality.

One method of preventing punch through is to use a cassette having a phosphor screen on only one side. Such screens are referred to as single-sided cassettes. However, phosphor screens are expensive and it would be desirable to use the same cassette for both dual coated transparent radiographic films and single sided reflective radiographic films.

Another method of preventing punch through is to incorporate an opacifying agent in one or more layers of the radiographic film at a level sufficient to prevent the punch through from the backside radiographic screen.

The opacifying agent may be any material that absorbs light at the wavelengths emitted from the backside intensifying screen. Exemplary opacifying agents include pigments, such as carbon black, titanium, or zinc oxide, or filter dyes. When filter dyes are used, it is preferable that they be removed during processing so that an undesirable color not remain on the developed radiograph film after processing.

This can be done using a black pigment such as Carbon Black, a blue pigment such as is contained within the radiographic film supports or a magenta pigment. An additional approach is to increase the amount of white titanium dioxide that is already added to the reflective radiographic film. The levels of these pigments are such that they can absorb all of the light produced by the back screen and eliminate punch through. These pigments can be permanent or they can be removed during processing to develop the radiograph. When removed during processing dyes often need to be decolorized in the processing solution. Permanent pigments such as carbon black or blue dyes have an additional benefit as they give the visual impression of conventional film based X-rays which is comforting to some radiologist who feel the white paper is too different to what they are used to seeing. Thus, a permanent black or blue pigment is preferred over a magenta pigment. The use of a neutral pigment such as carbon black is also effective in preventing punch through but the color of coated carbon black pigment tends to be brown-black and not visually pleasing. Blending of a blue dye with carbon black results in prevention of punch through and produces a more pleasing blue-black appearance.

Opacifying agents can be added to a hydrophilic layer either to the first major surface (frontside) or the second major surface (backside).

When added to a layer on the first major surface, the opacifying agent may be added to any layer coated between the radiographic support and the light sensitive emulsion layer. When added to a layer on the second major surface, the opacifying agent may be added to any layer coated on the second major surface. The opacifying agent may be added to the reflective polyester support as well. If desired, one or more opacifying agents may be added to one or more of these layers.

Another method of preventing punch through is to attach a black plastic sheet between the backside on the reflective film and the backside phosphor screen before imaging a single sided film. However, while useful, this is not a preferred method, as inadvertently omitting the sheet results punch through and a poor image. Inadvertently attaching the sheet to a dual sided film also results in a low quality image. In addition, dust can adhere to the black plastic and can be imaged onto the radiographic film creating artifacts. In addition, the back plastic may be creased inside the cassette

### Example 8

The following Example shows the effects of light transmitted through the backside of the support that “punches through” and images a single sided radiographic film having a reflective support.

Samples of green-sensitive radiographic films were prepared as described in Example 1. Samples were imaged as described in example 2 except that the x-ray voltage was increased to 120 KVp at 10 milliamperes for 100 milliseconds, and developed .using the developer and conditions described in Example 1E.

Sharpness was determined subjectively by a visual examination of the fine detail in a radiograph.

A piece of black plastic was inserted as an opacifying layer between the backside radiographic screen and the back of the reflective radiographic X-ray film and given a normal X-ray exposure. The data, shown below in TABLE XXIII, demonstrate that image density produced on the frontside of the radiographic film is higher when no opacifying layer is placed between the backside screen and the X-ray film. This is expected as the X-ray emulsion is imaged by light emitted from the frontside screen as well as by the light emitted by the backside screen. This “extra” density results from light emitted from the backside screen punching-through the support. However, the data shown in TABLE XXIII also show that the resulting image for the film without the black plastic opacifying layer is less sharp. Again, this is due to light emitted from the backside screen that punches through the support. This light is scattered by the support and results in a less sharp image.

TABLE XXIII

| | Optical Density | |
|---|---|---|
| | on the Frontside | Sharpness |
| Black plastic | 1.48 | 10 |
| No black plastic | 1.72 | 7 |

### Example 9

The following example was run to determine the required density of various opacifying materials needed to prevent punch through.

### Carbon Black:

A reflective radiographic film was placed in a dual screen X-ray cassette with the emulsion side placed towards the front screen. A piece of black plastic was placed against the front screen to eliminate exposure from the front screen. A neutral density step table was placed between the backside of the film and the back screen. A normal X-ray exposure was imparted on the film and the amount of density produced on the frontside of the developed radiographic film was measured. The amount of density produced was the result of the amount of back screen punch-through and corresponds to how much optical density was needed to prevent screen-light punch through. In the case of carbon black, this density was 0.93.

### Blue Dye

A reflective radiographic film was placed in a dual screen X-ray cassette with the emulsion side placed towards the front screen. A piece of black plastic was placed against the front screen to eliminate exposure from the front screen. A sheet of blue-tinted X-ray film support was placed on the backside of the film between the radiographic film and the neutral density step tablet. The radiographic film was exposed using a normal X-ray exposure and the image density produced on the frontside of the film was measured. This test is then repeated using two pieces of blue-tinted X-ray support and the amount of density produced on the frontside of the film was again measured. Additional sheets of blue-tinted support were sequentially added in this manner until no density was produced on the frontside of the film. The sum of neutral density provided by the blue-tinted support needed to eliminate an image on the frontside is the amount of blue dye needed to be coated on the backside of the film to prevent back screen punch-through. This density is approximately 1.2. These examples are summarized in TABLE XXIV.

TABLE XXIV
Density required to eliminate screen-light punch through

| Pigment | Density |
|---|---|
| Carbon black | 0.93 |
| Blue dye | 1.2 |

The invention has been described in detail with particular reference to certain preferred embodiments thereof, but it will be understood that variations and modifications can be effected within the spirit and scope of the invention.

1. A reflective radiographic silver halide film comprising a reflective support having first and second major surfaces, the reflective radiographic film having disposed only on the first major reflective support surface, one or more hydrophilic colloid layers including a silver halide emulsion layer, the radiographic film also containing in one or more of the hydrophilic colloid layers, an incorporated black-and-white developing agent and a co-developing agent, the mole ratio of the developing agent to the silver in the silver halide emulsion being equal to or greater than about 0.25:1 and less than about 0.7:1.

2. The reflective radiographic film of claim 1 having, after development, a maximum gamma of at least 1.7 and a gamma of at least 50% of its peak gamma over a 0.7 log E exposure range.

3. The reflective radiographic film of claim 1, wherein the developer comprises hydroquinone (HQ) and the co-developer comprises 4′-hydroxymethyl-4-methyl-1-phenyl-3-pyrazolidone (HMMP).

4. The reflective radiographic film of claim 1, wherein the weight ratio of incorporated developer to incorporated co-developer is at least 10:1.

5. The reflective radiographic film of claim 1 wherein one or more of the hydrophilic layers is an interlayer or an overcoat layer that does not contain a silver halide emulsion.

6. The reflective radiographic film of claim 1, further comprising an opacifying material located on the first major surface of the support between the emulsion layer and the support, within the support, or anywhere on the second major surface of the support.

7. The reflective radiographic film of claim 6, wherein the opacifying material has an optical density of from 0.9 to 4 at the wavelengths to which the photosensitive emulsion is spectrally sensitized.

8. The reflective radiographic film of claim 1, wherein:
the silver halide layer comprises tabular silver halide grains sensitized to blue or green light;
the developer comprises a hydroquinone (HQ) developer incorporated in the emulsion layer;
the co-developer comprises 4′-hydroxymethyl-4-methyl-1-phenyl-3-pyrazolidone (HMMP) incorporated within the emulsion layer;
the mole ratio of the developing agent to the silver in the silver halide emulsion being equal to or greater than about 0.25:1 and less than about 0.5:1; and
an opacifying material located on the first major surface of the support between the emulsion layer and the support, within the support, or anywhere on the second major surface of the support.

9. A reflective radiographic silver halide film comprising a reflective support having first and second major surfaces, the reflective radiographic film having disposed only on the first major reflective support surface, one or more hydrophilic colloid layers including a silver halide emulsion, the radiographic film also comprising in one or more of the hydrophilic colloid layers, an incorporated black-and-white developing agent and a co-developing agent, wherein the developing agent is coated at from about 1 to 20 mg/dm².

10. The reflective radiographic film of claim 9 having, after development, a maximum gamma of at least 1.7 and a gamma of at least 50% of its peak gamma over a 0.7 log E exposure range.

11. The reflective radiographic film of claim 9, wherein the developer comprises hydroquinone (HQ) and the co-developer comprises 4′-hydroxymethyl-4-methyl-1-phenyl-3-pyrazolidone (HMMP).

12. The reflective radiographic film of claim 9, wherein the weight ratio of incorporated developer to incorporated co-developer is at least 10:1.

13. The reflective radiographic film of claim 9, wherein one or more of the hydrophilic layers is an interlayer or an overcoat layer that does not contain a silver halide emulsion.

14. The reflective radiographic film of claim 9, further comprising an opacifying material located on the first major surface of the support between the emulsion layer and the support, within the support, or anywhere on the second major surface of the support.

15. The reflective radiographic film of claim 14, wherein the opacifying material has an optical density of from 0.9 to 6 at the wavelengths to which the photosensitive emulsion is spectrally sensitized.

16. The reflective radiographic silver halide film of claim 9, wherein:
the silver halide layer comprises tabular silver halide grains sensitized to blue or green light;
the developer comprises a hydroquinone (HQ) developer incorporated within the emulsion layer;
the co-developer comprises 4′-hydroxymethyl-4-methyl-1-phenyl-3-pyrazolidone (HMMP) incorporated within the emulsion layer;
the coating weight of the developing agent in the silver halide emulsion being from about 3 to about 7 mg/dm²; and
an opacifying material located on the first major surface of the support between the emulsion layer and the support, within the support, or anywhere on the second major surface of the support.

17. A radiographic silver halide film comprising a transparent support having first and second major surfaces, and having disposed on both major surfaces of the support, one or more hydrophilic colloid layers including a silver halide emulsion layer, the radiographic film also including in one or more of the hydrophilic colloid layers, an incorporated black-and-white developing agent and a co-developing agent, the mole ratio of the developing agent to the silver in the silver halide emulsion being equal to or greater than about 0.25:1 and less than about 1.5:1.

18. A radiographic silver halide film comprising a transparent support having first and second major surfaces, and having disposed on both major surfaces, one or more hydrophilic colloid layers including a silver halide emulsion layer, the radiographic film also containing in one or more of the hydrophilic colloid layers, an incorporated black-and-white developing agent and a co-developing agent, wherein the developing agent is coated at from about 1 to 20 mg/dm².

19. A method of providing a black-and-white image, comprising:
(A) contacting an exposed black-and-white silver halide film comprising an incorporated black-and-white developing agent and co-developing agent with a developer solution comprising a black-and white developing and co-developing agent, the incorporated developing agent being present in an amount of from about 1 to about 20 mg/dm², and the developer being present in the developer solution in an amount of from about 1 to about 10 g/l; and
(B) contacting the exposed silver halide film with a solution comprising a fixing agent.

20. The method of claim 19, wherein steps (A) and (B) are carried out (1) sequentially for at least 30 and up to 90 seconds for each step, or (2) sequentially, wherein step A is carried out for at least 30 and up to 120 seconds, and step B is carried out for at least 30 and up to 120 seconds.

21. A radiographic kit comprising:
one or more black-and-white radiographic silver halide films comprising a support that has first and second major surfaces, the radiographic film having disposed on at least one support major surface, one or more hydrophilic colloid layers including a silver halide emulsion layer, the radiographic film also containing an incorporated black-and-white developing agent and co-developing agent in one or more of the hydrophilic colloid layers;
one or more solutions of developer and co-developer; and
one or more solutions of fixer free of developer and co-developer.

22. A radiographic kit comprising:
a radiographic silver halide film comprising a support that has first and second major surfaces, the radiographic film having disposed on at least one support major surface, one or more hydrophilic colloid layers including a silver halide emulsion layer, the radiographic film also containing an incorporated black-and-white developing agent in one or more of the hydrophilic colloid layers;
a developer composition comprised of concentrations of less than 50 mmol/l of a primary developing agent, less than 2.5 mmol/l of a co-developing agent, and less than 0.075 mmol/l of an antifoggant and having a pH of less than about 12;
a fixing composition comprising less than 350 mmol/l of a fixing agent and less than 25 mmol/l of a hardening agent and having a pH in the range of about 4.0 to about 5.5; and
a phosphor screen.

23. The radiographic kit of claim 22, wherein the developer composition comprises from about 2 to about 5 g/l of developing agent and from about 0.25 to about 1 g/l of co-developing agent.

24. The radiographic kit of claim 22, wherein the developing agent is hydroquinone and the co-developing agent is 4′-hydroxymethyl-4-methyl-1-phenyl-3-pyrazolidone.
